(19) United States
(12) Patent Application Publication
(10) Pub. No.: US 2003/0107596 A1
(43) Pub. Date: Jun. 12, 2003

(54) Collection adaptive focus GUI

(76) Inventor: Kevin Wade Jameson, Calgary (CA)

Correspondence Address: KEVIN JAMESON, 148 EDGEBANK PLACE NW, CALGARY, AB, T3A 4L4, CA

(21) Appl. No.: 10/003,420

(22) Filed: Dec. 6, 2001

(51) Int. Cl. G09G 5/00; G06F 17/60

(52) U.S. Cl. 345/762; 345/778; 705/7

(57) ABSTRACT

A Collection Adaptive Focus GUI adapts to changes in user work situations, thereby providing human workers with a responsive, customized graphical user interface. Changes in work situations are indicated by various focusing events such as changing current work contexts, work locations, work objects, and work roles.

In operation, a Collection Adaptive Focus GUI receives work situation change events and adaptively responds by updating various GUI functional elements to correspond to the new work situation.

Collection Adaptive Focus GUIs thus provide users with GUI interfaces that are precisely adapted to the specific characteristics of each new user work situation, thereby increasing the productivity of human workers in ways that were not previously possible.

### CROSS REFERENCES TO RELATED APPLICATIONS

The present invention uses inventions from the following patent applications, which are incorporated herein by reference:

Collection Information Manager USPTO patent application Ser. No. 09/885078 filed Jun. 21, 2001, Kevin W Jameson.

Collection Knowledge System USPTO patent application Ser. No. 09/885079 filed Jun. 21, 2001, Kevin W Jameson.

Collection Extensible Action GUI, USPTO patent application filed contemporaneously herewith, Kevin W Jameson.

Collection Role Changing GUI, USPTO patent application filed contemporaneously herewith, Kevin Jameson.

### FIELD OF THE INVENTION

This invention relates to graphical user interfaces for processing collections of computer files in arbitrary ways, thereby improving the productivity of software developers, web media developers, and other humans that work with collections of computer files.

### BACKGROUND OF THE INVENTION

The Overall Problem

The general problem addressed by this invention is the low productivity of human knowledge workers who use labor-intensive manual processes to work with collections of computer files. One promising solution strategy for this software productivity problem is to build automated systems to replace manual human effort.

Unfortunately, replacing arbitrary manual processes performed on arbitrary computer files with automated systems is a difficult thing to do. Many challenging sub-problems must be solved before competent automated systems can be constructed. As a consequence, the general software productivity problem has not been solved yet, despite large industry investments of time and money over several decades.

The present invention provides one piece of the overall functionality required to improve the productivity of human knowledge workers—an adaptable GUI user interface. In particular, the present Collection Adaptive Focus GUI invention has a practical application in the technological arts because it provides a graphical user interface that can dynamically adapt to changes in user work situations, thereby making it easier for users to perform work in more efficient ways.

Five conceptual models are required to explain adaptive behavior: (1) work situations, (2) work situation change events, (3) work situation adaptation knowledge, (4) adaptive user interfaces, and (5) technical means for using work situation adaptation knowledge to adapt user interfaces in response to work situation change events.

Conceptual models for work situations and user interfaces are described in this background section. Other conceptual models are described later, in the detailed description.

Work Environments

Software work environments are the software circumstances in which knowledge workers carry out their daily work tasks. For example, a command line shell window on an operating system is a typical command line software work environment.

Software work environments provide access to sets of work operations that are used by humans to accomplish various data processing tasks.

Work Operations

Work operations are computer programs, or computer scripts, that carry out computer actions. Typical examples of work operations include printing documents, performing calculations, and processing data files with application programs.

The default set of work operations made available by a computer operating system is called the default command set of the operating system. In practice, default operating system command sets are always extended with additional programs to provide users with application-specific work operations. Thus the total set of work operations available in a typical command line shell window is the union of the default operating system command set and the additional application-specific work operation set.

The total number of available work operations in a typical software environment can be large. At least hundreds—and often thousands—of distinct work operations are available on modern computers. The complexity of such a large set of work operations imposes a significant knowledge burden on human workers.

Types of Work Operations

Four types of work operations are of interest for this discussion: operating system work operations, application program work operations, scripted work process operations, and variant process operations. These four types of work operations are presented in approximate order of increasing complexity.

Operating system work operations are the fundamental set of work operations that are available for use in work situations. These operations are provided by the operating system in the form of individual computer programs. In most operating systems, a shell window command line user interface provides access to these work operations.

Application-specific work operations provide additional functionality for accomplishing application-specific work. These work operations are normally provided by individual application programs. In most operating systems, a shell window command line user interface provides access to these application-oriented work operations.

Scripted work process operations provide process-level functionality to user interfaces. Scripted work process operations are normally provided by scripts, batch files, or custom programs that involve more complexity than individual operating system and application work operations. In most operating systems, a shell window command line user interface provides access to scripted work operations.

Variant process work operations provide variant process-level functionality to user interfaces. Like scripted process operations, variant process work operations are normally provided by scripts, batch files, and custom programs. In most operating systems, a shell window command line interface provides access to variant process work operations.

Work Events

Work events are used to invoke work operations. Specifically, work events are computer signals that cause work operations to be carried out. Work events are usually implemented by command line interfaces or GUIs (graphical user interfaces).

Here are some examples of work events—clicking a GUI menu choice, clicking a GUI toolbar button, or typing a computer command line in a shell window. In these examples, a human initiates the work event; in turn, the work event invokes a work operation to perform a desired computational action.

In sequence: humans invoke work events, work events invoke work operations, and work operations perform computational work such as processing data files—thus work proceeds within a software work environment.

Work Processes

Work processes are sequences of work operations. Sequences of work operations are useful because individual work operations are usually too small to completely perform routine work tasks. Sequences of work operations—work processes—are implemented by means such as batch files, scripts, and computer programs.

Work processes have two important characteristics that limit productivity and increase software development costs: narrowness of function, and brittleness of behavior.

Narrowness of function means that work processes can be used only to solve the original application that motivated their construction. They “break,” and do not produce the desired result if they are used for anything even slightly different than the original application. Narrowness of function is usually caused by development teams that try to save time and money by designing and building a minimally optimal solution for the motivating problem at hand.

Brittleness of behavior describes what happens when narrow work processes are applied to problems that differ from the original application. Total functional failure is the usual result—most work processes are too brittle to handle even small variances in process inputs.

Narrowness of function and brittleness of behavior reduce productivity and increase costs because they prevent existing work processes from being reused on different problems. Instead, special variant work processes must be constructed—at additional cost—to solve the different problems.

Variant Work Processes

Variant work processes are work processes that differ from each other in small but significant ways. Variant processes are typically required to solve variant work problems.

One example of a variant work problem involving minor differences is the problem of compiling source code modules with various compilation options enabled (same compiler, different options). Another example, this time involving major differences, is compiling source code modules for different computing platforms (different compilers, different options, different command sequences).

A third example is upgrading existing work processes with various combinations of new software programs from different software vendors. Still another example is modifying an existing work process to enable testing activities in personal home directories instead of in team or site working directories.

Variant work processes are important because they increase software project costs and schedules. They are also difficult to avoid because many project factors drive the demand for variant work processes. As a result, variant problems and processes are ubiquitous in software work situations, even though they are costly, undesirable, and unwanted.

Work Situations

Work situations are another name for work circumstances. Work situations can be usefully described by answers to these familiar six questions: Who? What? Why? Where? When? and How?

For example, consider a work situation in which a programmer must debug a production program after normal working hours.

The work situation is defined by answers to the six questions: Who?—the programmer, operating in a debugging role. What?—the program to be debugged. When?—after normal working hours. Where?—in the programmer's home directory. Why?—to debug the program. How?—using the programmer's favorite set of debugging tools, and special after-hours tools to access the company repositories after normal working hours.

The answers could also indicate the character of the work situation, as follows:

Who?—The role of debugger could indicate that personal program options for debugging should be used in preference to system default program debugging options.

What?—The name of the program to be debugged could indicate that special methods or debugging processes for that particular program should be made available to the programmer.

When?—The time of after normal working hours could indicate that appropriate time-sensitive special security permissions, file access methods, or computer resource constraints should be used.

Where?—The location of a home directory could indicate that personal software programs should be used in preference to system default programs.

Why?—The purpose of debugging could indicate that work operations should run in debug mode, if possible.

How?—Previous answers could indicate how software processes within the work situation should be implemented to fit the particular needs of the work situation.

Work situations are complex. As shown above, work situations have six degrees of freedom in which to vary. This variance—and six degrees of freedom is a lot of it—increases software project costs because it adds to project complexity and drives the demand for costly special variant work processes.

Variant Work Situations

Variant work situations are work situations that differ in small but significant ways. The main sources of variance in variant work situations are variant work processes, which are in turn driven by variant work problems.

Variant work situations are important because they determine the work events, work processes, and work operations that are required by human users to accomplish the work at hand.

Multiple Work Situations

Multiple work situations are not the same as variant work situations. Multiple work situations differ in major ways, and so are not considered to be variants of each other. In contrast, variant work situations differ in minor ways, and are commonly viewed as close variants of each other.

As an example of the difference between multiple and variant work situations, consider a programmer who works on several different things during a routine day: on a website, on a program, and on a document. Since each work situation is significantly different they are called multiple work situations, not variant work situations.

Multiple Variant Work Situations

Multiple variant work situations are comprised of multiple instances of normal variant work situations. Multiple variant work situations are important because they accurately reflect the work patterns of typical human workers in the information industry. That is, human workers are usually involved in multiple work situations, each with (possibly many) variant forms.

It follows that to encourage maximum productivity, effective user interfaces must support the model of multiple variant work situations.

This concludes the background discussion on models for multiple variant work situations. In sequence: work environments offer user interfaces; user interfaces offer work events to humans; humans use work events to invoke work processes; work processes execute work operations; and work operations perform useful work.

The discussion now turns to the main subject of the current invention, how adaptive GUI user interfaces can adapt to new work situations to improve human productivity.

The Purpose Of User Interfaces

User interfaces are software programs that provide humans with access to work events and work operations, thereby enabling the human workers to accomplish their desired work goals within a software environment.

In sequence: user interfaces provide work events to human workers; human workers invoke work events; work events invoke work processes; work process invoke work operations; and work operations process data files—thus work is accomplished with the help of user interfaces.

The main goal of user interfaces is to facilitate human productivity by making it both convenient and efficient for humans to accomplish work. To this end, various kinds of user interfaces have been created over the years to improve user productivity.

Adaptive User Interfaces and Work Situations

For optimal human productivity, user interfaces should support multiple variant work situations, as modeled by the six Who, What, When, Where, Why and How questions. User interfaces should also adapt to new work situations, thereby providing users with sets of work events that are precisely tuned to to new variant work situations.

User interfaces should, but they don't.

Instead, current user interfaces provide only limited support for multiple variant work situations and adaptive behavior. Many problems must be solved in order to build adaptive GUI interfaces that can adapt to multiple variant work situations.

Problems to Solve

The Adaptive Focus GUI Problem is an important overall problem that must be solved to improve the adaptability of GUI interfaces. It is the problem of how to detect and how to react to changes among multiple variant work situations.

Some interesting aspects of the Adaptive Focus GUI problem are these: changes in work situations can be driven by four types of inputs—who, what, where, when, and why; models for representing and managing change events for all five types of inputs are required; a model for representing and managing multiple variant processes is required; and the GUI display must be adapted and updated in real time as changes to work situations occur.

The Work Purpose Adaptation Problem (why) is another important problem that must be solved to enable the construction of adaptive user interfaces. It is the problem of modeling and managing purpose-sensitive changes in work situations. For example, if the purpose of a work situation is changed from debugging to production, all purpose-sensitive aspects of an adaptive user interface must be updated to reflect the change. For instance, work roles may contain purpose-sensitive variant work operations within the role.

Some interesting aspects of the Work Purpose Adaptation Problem are these: an arbitrary number of user-defined purposes are possible; each purpose can call for variant behaviors in the other five aspects (where, what, who, when, how) of the work situation; each purpose can affect the functionality of an adaptive GUI interface.

The Work Location Adaptation Problem (where) is another important problem that must be solved to enable the construction of adaptive user interfaces. It is the problem of modeling and managing location-sensitive changes in work situations. For example, when users change directories into a particular computer filesystem work area—such as a directory for working on websites—an adaptive user interface should detect and react to the change by displaying and enabling web site work operations on the GUI interface.

Some interesting aspects of the Work Location Adaptation Problem are these: arbitrary numbers of user-defined work locations are possible; the behavior of many things—work roles, events, operations, processes—may vary with location; work locations can be given symbolic names; work locations can be associated with attributes and properties; work locations may be directly associated with named sets of attributes and properties; work locations can inherit properties from ancestor locations in computer filesystems; and all location-sensitive adaptations may be customized for site, team, and personal use.

The Work Object Type Adaptation Problem (what) is another important problem that must be solved to enable the construction of adaptive user interfaces. It is the problem of modeling and managing changes in work situations that are sensitive to work object types. For example, websites, programs, documents are all examples of different types of work objects. An adaptive user interface should provide website work events for working on work objects of type “website”; program work events for working on work objects of type “program”; document work events for working on work objects of type “document”; and so on.

Collections are a useful model for work objects and types of work objects. Collections are sets of computer files that can be manipulated as a set, rather than as individual files. Collection are comprised of three major parts: (1) a collection specifier that contains information about a collection instance, (2) a collection type definition that contains information about how to process all collections of a particular type, and (3) optional collection content in the form of arbitrary computer files that belong to a collection. Collections are further described in the related patent applications listed at the beginning of this document.

Some interesting aspects of the Work Object Type Adaptation problem are these: adaptation should be performed according to the type of work object; arbitrary numbers of user-defined work objects and work object types are possible; each work object may be comprised of a collection of multiple computer files; work objects, if implemented as collections, may be comprised of one primary object and multiple sub-objects, each with a distinct type. Further, selection of a particular work object using an adaptive interface should cause an associated role to be used; special variant versions of normal processes to be used; additional work operations for the particular work object to be used; and all work object adaptations may be customized for site, team, and personal use.

The Work Role Adaptation Problem (who) is another important problem that must be solved to enable the construction of adaptive user interfaces. It is the problem of modeling and managing role-sensitive changes in work situations. For example, if a programmer changes from a debugging role to a documentation role in a work situation, an adaptive GUI user interface should remove debugging work events from the interface and should add documentation work events.

Some interesting aspects of the Work Role Adaptation Problem are these: arbitrary numbers of user-defined roles are possible; arbitrary types of roles are possible (each specifying arbitrary changes to the menus, toolbars, and underlying methods used by the user interface); roles may have platform dependent behavior; particular roles can be associated with particular types of work objects; and roles may be customized for site, team, and personal use.

The Work Time Adaptation Problem (when) is another important problem that must be solved to enable the construction of adaptive user interfaces. It is the problem of modeling and managing time-sensitive changes in work situations. For example, some work operations may become unavailable after normal working hours (e.g. for security reasons). An adaptive GUI user interface should detect and react to these changes by removing affected work events from the GUI display.

Some interesting aspects of the Work Time Adaptation problem are these: arbitrary numbers of time-sensitive, user-defined work events are possible; the behavior of many things—work roles, events, operations, processes—may vary with time; and all time-sensitive adaptations may be customized for site, team, and personal use.

The Work Method Adaptation Problem (how) is another important problem that must be solved to enable the construction of adaptive user interfaces. It is the problem of modeling, managing, and adapting user interface implementation methods to fit other changes in work situations. Note that methods—the sixth question of “how”—are not change inputs to a work situation, but instead are change consequences.

For example, suppose a work situation provides work events to compile a program in two different ways (using two different compilers) called Compiler-A and Compiler-B. Because the two methods have two different names, they can both coexist in the same work situation; programmers can use either compiler in the same work situation. Now suppose the purpose of the work situation changes from debugging to production, thereby requiring changes in the variant work processes for Compiler-A and Compiler-B. (To be precise, the change would consist of turning off compiler debugging options, and turning on optimization options, in both compilation methods.) This example shows that the work method adaptation problem is not the same as the previous five problems: work methods must be adapted as a consequence of—not as a cause of—other changes in work situations.

The Work Object Instance Adaptation Problem is another important problem that must be solved to enable the construction of useful adaptive user interfaces. It is the problem of adapting user interfaces in accordance with peculiar characteristics of particular work objects. Note this problem calls for adapting the interface to data contained within particular work objects, rather than to the types of particular work objects.

Some interesting aspects of the Work Object Instance Adaptation Problem are these: arbitrary numbers of work objects may be involved; arbitrary combinations of other work situation value specifiers (such as role values and time values) may be involved.

The Work Situation Focus Actions Problem is another important problem that must be solved to enable the construction of useful adaptive user interfaces. It is the problem of performing useful focus loss and focus gain actions when a GUI adapts from one work situation to another work situation. Actions performed as focus is removed from a work situation are called Focus Loss Actions. Actions performed as focus is placed on a work situation are called Focus Gain Actions.

Some interesting aspects of the Work Situation Focus Actions Problem are these: arbitrary numbers of focus gain and focus loss actions may be involved; actions can be specified in a variety of places including various full and partial situation definition files, context definition files, collection type definition files, collection specifier files, role definition files, and timeset definition files; actions may be implemented in various ways including internal GUI subroutine calls, externally spawned commands, or as more complex menu choice definitions. (Contexts are further described in the related patent applications listed at the beginning of this document.)

The Partial Situation Expansion Problem is another important problem that must be solved to enable the construction of useful adaptive user interfaces. It is the problem of how to expand a partial situation definition into a full situation definition using predefined partial situation expansion policies.

Some interesting aspects of the Partial Situation Expansion Problem are these: each partial situation policy must specify a method of calculating all major full situation values from a single partial situation change value; an arbitrary number of partial situation expansion policies may be defined; partial situations can be expanded using specific match values that cause whole named full situations to shortcut the expansion process; partial situations can be expanded using situation values that are derived from previously defined situation values; and partial situations can be expanded using situation values that are explicitly specified by partial situation policies.

The Customized Adaptation Data Problem is another important problem that must be solved to enable the construction of useful adaptive user interfaces. It is the problem of how to represent and manage all site, project, team, and individual customizations for data used by a Collection Adaptive Focus GUI.

Some interesting aspects of the Customized Adaptation Data Problem are these: arbitrary numbers of work situations and partial work situations may be customized; arbitrary numbers of site, team, project, and individual customizations may be involved; customizations can be platform dependent; customizations can be shared among GUI users; and centralized administration of shared customizations is desirable.

The Sharable Adaptation Data Problem is another important problem that must be solved to enable the construction of useful adaptive user interfaces. It is the problem of sharing user-defined adaptation data among all users and machines in a networked computing environment.

Some interesting aspects of the Sharable Adaptation Data Problem are these: arbitrary numbers of users may be involved; users may be organized into groups of related users that share the same adaptation data; individual customizations to shared group adaptation data values may also be shared; centralized administration of data sharing rules is desirable.

The Scalable Adaptation Data Storage Problem is another important problem that must be solved to enable the construction of useful adaptive user interfaces. It is the problem of how to manage large quantities of multi-platform adaptation data in a networked computing environment.

Some interesting aspects of the Scalable Adaptation Data Storage Problem are these: arbitrary quantities of adaptation data may be involved; adaptation data can be accessed by any computer on the network; groups of related adaptation data values can be identified, and can be shared among many different users and platforms; centralized administration of stored adaptation data is desirable.

As the foregoing discussion suggests, creating adaptive graphical user interfaces for multiple variant work situations is a complex problem involving six degrees of freedom. No competent general solution to the overall problem is visible in the prior art today, even though the first graphical user interfaces were created over 30 years ago.

General Shortcomings of the Prior Art

The following discussion is general in nature, and highlights the significant conceptual differences between the file-oriented, application-centered user interface mechanisms of the prior art, and the novel collection-oriented, adaptive-focus graphical user interface represented by the present invention.

Prior art approaches lack support for adaptive behavior. This is the largest limitation of all because it prevents prior art approaches from adapting to particular work situations and thereby improving human productivity.

Prior art approaches lack support for understanding multiple variant work situations. As a consequence, they cannot detect changes in work situations, and cannot adapt accordingly.

Prior art approaches lack support for adapting themselves in response to changes in user work purposes (why).

Prior art approaches lack support for adapting themselves in response to changes in user work locations (where).

Prior art approaches lack support for adapting themselves in response to changes in user work objects (what).

Prior art approaches lack support for adapting themselves in response to changes in user work roles (who).

Prior art approaches lack support for adapting themselves in response to changes in user work times (when).

Prior art approaches lack support for adapting their work methods (how) in response to changes in work roles, objects, locations, times, and purposes.

Prior art approaches lack support for customizing large numbers of work situations involving various purposes, locations, objects, roles, times, events, operations, and processes, thereby making it impossible to simultaneously serve the customization needs of human workers that each participate in multiple variant work situations.

As can be seen from the above description, prior art user interface approaches have several important limitations. Notably, they do not support adaptive behavior, multiple variant work situations, collections, or customized work situation adaptation knowledge.

In contrast, the present Collection Adaptive Focus GUI invention has none of these limitations, as the following disclosure will show.

### SUMMARY OF THE INVENTION

A Collection Adaptive Focus GUI is a graphical user interface that dynamically adapts to changes in work situations, thereby providing human workers with a more productive user interface.

In operation, a Collection Adaptive Focus GUI receives work situation change events, and responds by adapting itself to new work situations, thereby providing human workers with work events, work operations, and work processes that are specifically matched to the newly changed work situation. All adaptation knowledge used by the GUI is customizable and extensible.

A Collection Adaptive Focus GUI is therefore a novel graphical user interface—adaptive, customizable, extensible, sharable, and scalable—that enables human workers to be more productive, in ways that were not previously possible.

### OBJECTS AND ADVANTAGES

The main object of an Collection Adaptive Focus GUI is to provide a GUI user interface that can adapt to changes in multiple variant work situations, and thereby provide human workers with a more productive user interface.

Another object is to provide support for multiple variant work situations, thereby making it possible for humans to construct work situation representations to fit their computational needs.

Another object is to provide support for adapting the user interface to changes in user work purposes.

Another object is to provide support for adapting the user interface to changes in user work locations.

Another object is to provide support for adapting the user interface to changes in user work objects, especially where the work objects are collections.

Another object is to provide support for adapting the user interface to changes in user work roles.

Another object is to provide support for adapting the user interface to changes in user work times.

Another object is to provide support for adapting user interface work methods—work operations and processes—in accordance with changes in work roles, objects, locations, times, and purposes.

Another object is to provide support for managing customized definitions of multiple variant work situations.

Another object is to provide support for managing customized definitions for work roles, objects, locations, times, and purposes.

As can be seen from the objects above, Collection Adaptive Focus GUIs can provide many benefits to human knowledge workers. Collection Adaptive Focus GUIs can help to improve human productivity by optimally adapting to changes in multiple variant work situations, in ways that were not previously possible.

Further advantages of the present Collection Adaptive Focus GUI invention will become apparent from the drawings and disclosures that follow.

### BRIEF DESCRIPTION OF DRAWINGS

FIG. 1 shows a sample prior art filesystem folder in a typical personal computer filesystem.

FIG. 2 shows how a portion of the prior art folder in FIG. 1 has been converted into a collection 100 by the addition of a collection specifier file 102 named “cspec” FIG. 2 Line 5.

FIG. 3 shows an example physical representation of a collection specifier 102, implemented as a simple text file such as would be used on a typical personal computer filesystem.

FIG. 4 shows four major information groupings for collections, including collection type definition 101, collection specifier 102, collection content 103, and collection 100.

FIG. 5 shows a more detailed view of the information groupings in FIG. 4, illustrating several particular kinds of per-collection-instance and per-collection-type information.

FIG. 6 shows a logical diagram of how a Collection Information Manager Means 111 would act as an interface between an application program means 110 and a collection information means 107, including collection information sources 101-103.

FIG. 7 shows a physical software embodiment of how an Application Program Means 110 would use a Collection Information Manager Means 111 to obtain collection information from various collection information API means 112-114 connected to various collection information server means 115-117.

FIG. 8 shows an example software collection datastructure that relates collection specifier and collection content information for a single collection instance.

FIG. 9 shows an example collection type definition datastructure, such as might be used by software programs that process collections.

FIG. 10 shows a more detailed example of the kinds of information found in collection type definitions.

FIG. 11 shows a simplified architecture for a Collection Adaptive Focus GUI 130.

FIG. 12 shows a simplified algorithm for a Collection Adaptive Focus GUI 130.

FIG. 13 shows a simplified architecture for a Module Adaptive Response Manager 131.

FIG. 14 shows a simplified algorithm for a Module Adaptive Response Manager 131.

FIG. 15 shows a simplified architecture for a Module Get Full Situation Change 140.

FIG. 16 shows a simplified algorithm for a a Module Get Full Situation Change 140.

FIG. 17 shows an example full situation name table Lines 1-6 and a corresponding symbolic full situation definition file Lines 7-17.

FIG. 18 shows a list of possible situation values for use in full and partial situation definition files.

FIG. 19 shows an example full situation definition file for working on a program collection and its four associated library collections.

FIG. 20 shows an example full situation definition file for working on a new HTML document.

FIG. 21 shows an example situation type name table Lines 1-4 and two situation type definition files beginning on Lines 5 and 13 respectively.

FIG. 22 shows a simplified architecture for a Module Set Full Situation Change 200.

FIG. 23 shows a simplified algorithm for a Module Set Full Situation Change 200.

FIG. 24 shows a simplified algorithm for a Module Set Search Rule Situation Changes 201.

FIG. 25 shows a simplified algorithm for a Module Set Lookup Situation Changes 210.

FIG. 26 shows an example context name table.

FIG. 27 shows an example base directory name table.

FIG. 28 shows an example role name table Lines 1-5 and two example role definition files beginning on Lines 6 and 10 respectively.

FIG. 29 shows an example timeset name table Lines 1-5 and an example timeset definition file Lines 6-26.

FIG. 30 shows examples of typical focus variables and their values.

FIG. 31 shows an example focus group name table Lines 1-14 and two example focus group definition files beginning on Lines 15 and 20 respectively.

FIG. 32 shows an example GUI layout name table Lines 1-4 and two example layout definition files beginning on Lines 5 and 11 respectively.

FIG. 33 shows an example GUI menu choice definition that uses a focus variable substitution technique to dynamically construct a shell command for later execution.

FIG. 34 shows a simplified architecture for a Module Expand Partial Situation 150.

FIG. 35 shows a simplified algorithm for a Module Expand Partial Situation 150.

FIG. 36 shows an example partial situation policy name table Lines 1-4 and an example partial situation policy definition file Lines 5-28.

FIG. 37 shows an example partial situation policy definition file that contains partial situation blocks that use specific partial situation values Lines 14-15, 23-24.

FIG. 38 shows a simplified algorithm for a Module Expand Partial Situation Role 155.

FIG. 39 shows a simplified algorithm for deriving partial situation values from the definition files of previously determined situation values.

FIG. 40 shows a simplified event data structure containing both incoming event data Lines 3-5 and expanded full situation data Lines 6-13.

FIG. 41 shows an example collection specifier that contains work situation value specifiers Lines 4-6 that override work situation values calculated using the main method of calculating work situation values.

FIG. 42 shows an example full situation definition file containing focus-gain and focus-loss action specifiers.

### LIST OF DRAWING REFERENCE NUMBERS

100 A collection formed from a prior art folder

101 Collection type definition information

102 Collection specifier information

103 Collection content information

104 Per-collection collection processing information

105 Per-collection collection type indicator

106 Per-collection content link specifiers

107 Collection information

110 Application program means

111 Collection information manager means

112 Collection type definition API means

113 Collection specifier API means

114 Collection content API means

115 Collection type definition server means

116 Collection specifier server means

117 Collection content server means

121 Adaptive Data Storage Means

130 Collection Adaptive Focus GUI

131 Module adaptive response manager

132 Module work situation focus loss manager

140 Module get full situation change

141 Module get situation change type

142 Module get named full situation

150 Module expand partial situation

151 Module get partial situation policy

152 Module expand partial situation context

153 Module expand partial situation base directory

154 Module expand partial situation collection

155 Module expand partial situation role

156 Module expand partial situation timeset

200 Module set full situation change

201 Module set search rule situation changes

202 Module set situation context

203 Module set situation base directory

204 Module set situation collection

210 Module set lookup situation changes

211 Module set situation role

212 Module set situation timeset

213 Module set situation focus variables

214 Module set situation focus variable groups

250 Module Redisplay GUI layout

### DETAILED DESCRIPTION

Overview of Collections

This section introduces collections and some related terminology.

Collections are sets of computer files that can be manipulated as a set, rather than as individual files. Collection are comprised of three major parts: (1) a collection specifier that contains information about a collection instance, (2) a collection type definition that contains information about how to process all collections of a particular type, and (3) optional collection content in the form of arbitrary computer files that belong to a collection.

Collection specifiers contain information about a collection instance. For example, collection specifiers may define such things as the collection type, a text summary description of the collection, collection content members, derivable output products, collection processing information such as process parallelism limits, special collection processing steps, and program option overrides for programs that manipulate collections. Collection specifiers are typically implemented as simple key-value pairs in text files or database tables.

Collection type definitions are user-defined sets of attributes that can be shared among multiple collections. In practice, collection specifiers contain collection type indicators that reference detailed collection type definitions that are externally stored and shared among all collections of a particular type. Collection type definitions typically define such things as collection types, product types, file types, action types, administrative policy preferences, and other information that is useful to application programs for understanding and processing collections.

Collection content is the set of all files and directories that are members of the collection. By convention, all files and directories recursively located within an identified set of subtrees are usually considered to be collection members. In addition, collection specifiers can contain collection content directives that add further files to the collection membership. Collection content is also called collection membership.

Collection is a term that refers to the union of a collection specifier and a set of collection content.

Collection information is a term that refers to the union of collection specifier information, collection type definition information, and collection content information.

Collection membership information describes collection content.

Collection information managers are software modules that obtain and organize collection information from collection information stores into information-rich collection data structures that are used by application programs.

Collection Physical Representations—Main Embodiment

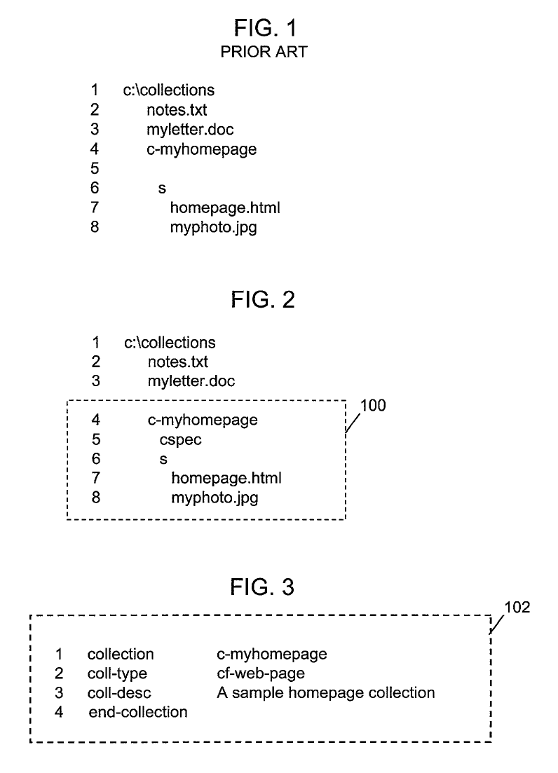

FIGS. 1-3 show the physical form of a simple collection, as would be seen on a personal computer filesystem.

FIG. 1 shows an example prior art filesystem folder from a typical personal computer filesystem.

FIG. 2 shows the prior art folder of FIG. 1, but with a portion of the folder converted into a collection 100 by the addition of a collection specifier file FIG. 2 Line 5 named “cspec”. In this example, the collection contents 103 of collection 100 are defined by two implicit policies of a preferred implementation.

First is a policy to specify that the root directory of a collection is a directory that contains a collection specifier file. In this example, the root directory of a collection 100 is a directory named “c-myhomepage” FIG. 2 Line 4, which in turn contains a collection specifier file 102 named “cspec” FIG. 2 Line 5.

Second is a policy to specify that all files and directories in and below the root directory of a collection are part of the collection content. Therefore directory “s” FIG. 2 Line 6, file “homepage.html” FIG. 2 Line 7, and file “myphoto.jpg” FIG. 2 Line 8 are part of collection content 103 for said collection 100.

FIG. 3 shows an example physical representation of a collection specifier file 102, FIG. 2 Line 5, such as would be used on a typical personal computer filesystem.

Collection Information Types

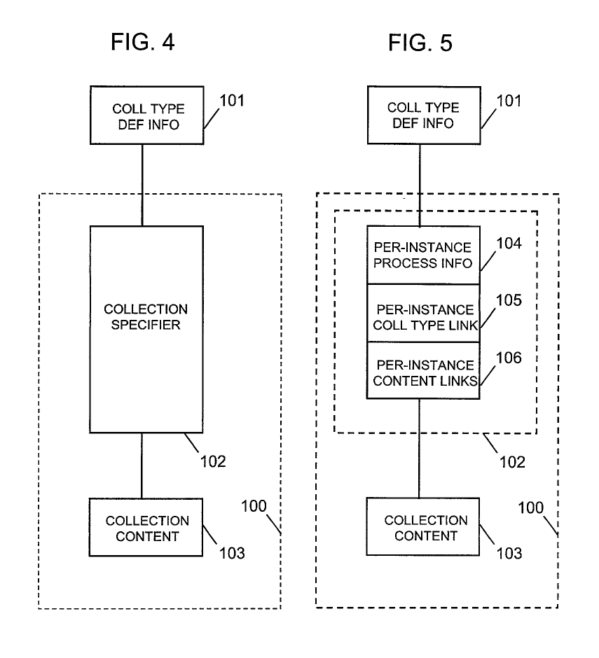

FIGS. 4-5 show three main kinds of information that are managed by collections.

FIG 4 shows a high-level logical structure of three types of information managed by collections: collection processing information 101, collection specifier information 102, and collection content information 103. A logical collection 100 is comprised of a collection specifier 102 and collection content 103 together. This diagram best illustrates the logical collection information relationships that exist within a preferred filesystem implementation of collections.

FIG. 5 shows a more detailed logical structure of the same three types of information shown in FIG. 4. There is only one instance of collection type information 101 per collection type. There is only one instance of collection content information per collection instance. Collection specifier information 102 has been partitioned into collection instance processing information 104, collection-type link information 105, and collection content link information 106. FIG. 5 is intended to show several important types of information 104-106 that are contained within collection specifiers 102.

Suppose that an application program means 110 knows (a) how to obtain collection processing information 101, (b) how to obtain collection content information 103, and (c) how to relate the two with per-collection-instance information 102. It follows that application program means 110 would have sufficient knowledge to use collection processing information 101 to process said collection content 103 in useful ways.

Collection specifiers 102 are useful because they enable all per-instance, non-collection-content information to be stored in one physical location. Collection content 103 is not included in collection specifiers because collection content 103 is often large and dispersed among many files.

All per-collection-instance information, including both collection specifier 102 and collection content 103, can be grouped into a single logical collection 100 for illustrative purposes.

Collection Application Architectures

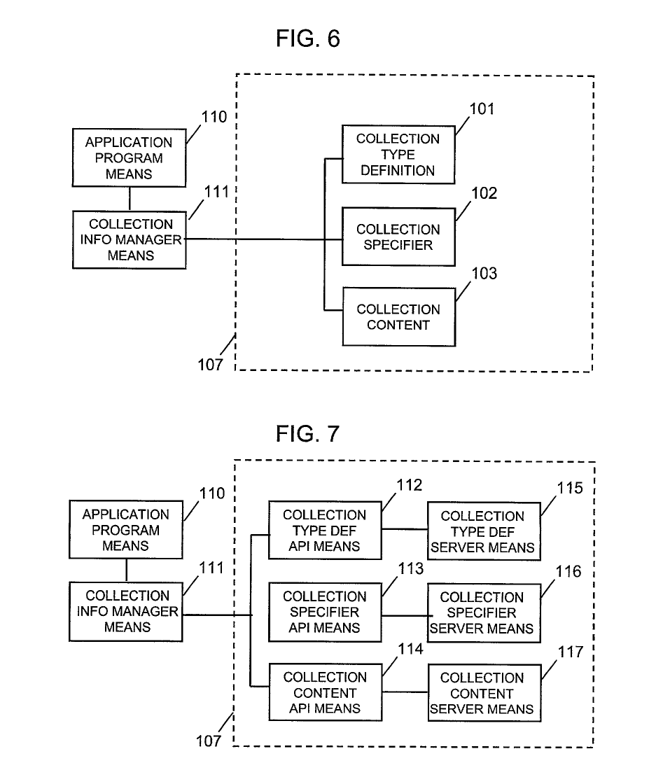

FIGS. 6-7 show example collection-enabled application program architectures.

FIG. 6 shows how a collection information manager means 111 acts as an interface between an application program means 110 and collection information means 107 that includes collection information sources 101-103. Collectively, collection information sources 101-103 are called a collection information means 107. A collection information manager means 111 represents the union of all communication mechanisms used directly or indirectly by an application program means 110 to interact with collection information sources 101-103.

FIG. 7 shows a physical software embodiment of how an application program means 110 could use a collection information manager means 111 to obtain collection information from various collection information API (Application Programming Interface) means 112-114 connected to various collection information server means 115-117.

Collection type definition API means 112 provides access to collection type information available from collection type definition server means 115. Collection specifier API means 113 provides access to collection specifier information available from collection specifier server means 116. Collection content API means 114 provides access to collection content available from collection content server means 117.

API means 112-114, although shown here as separate software components for conceptual clarity, may optionally be implemented wholly or in part within a collection information manager means 111, or within said server means 115-117, without loss of functionality.

API means 112-114 may be implemented by any functional communication mechanism known to the art, including but not limited to command line program invocations, subroutine calls, interrupts, network protocols, or file passing techniques.

Server means 115-117 may be implemented by any functional server mechanism known to the art, including but not limited to database servers, local or network file servers, HTTP web servers, FTP servers, NFS servers, or servers that use other communication protocols such as TCP/IP, etc.

Server means 115-117 may use data storage means that may be implemented by any functional storage mechanism known to the art, including but not limited to magnetic or optical disk storage, digital memory such as RAM or flash memory, network storage devices, or other computer memory devices.

Collection information manager means 111, API means 112-114, and server means 115-117 may each or all optionally reside on a separate computer to form a distributed implementation. Alternatively, if a distributed implementation is not desired, all components may be implemented on the same computer.

Collection Data Structures

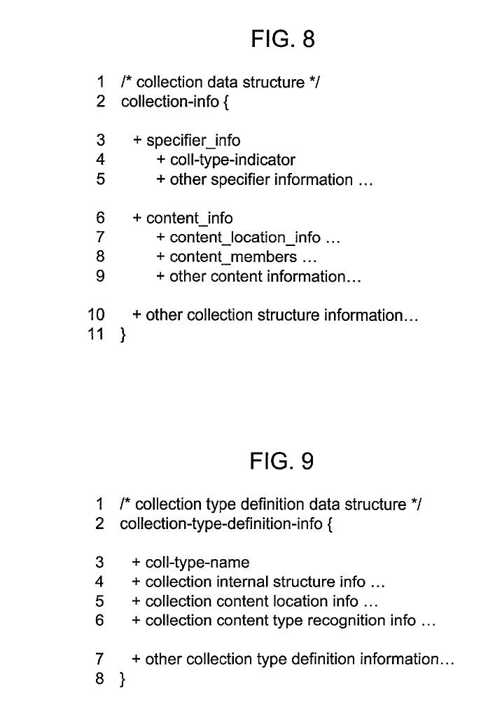

FIGS. 8-10 show several major collection data structures.

FIG. 8 shows an example collection datastructure that contains collection specifier and collection content information for a collection instance. Application programs could use such a datastructure to manage collection information for a collection that is being processed.

In particular, preferred implementations would use collection datastructures to manage collection information for collections being processed. The specific information content of a collection datastructure is determined by implementation policy. However, a collection specifier typically contains at least a collection type indicator FIG. 8 Line 4 to link a collection instance to a collection type definition.

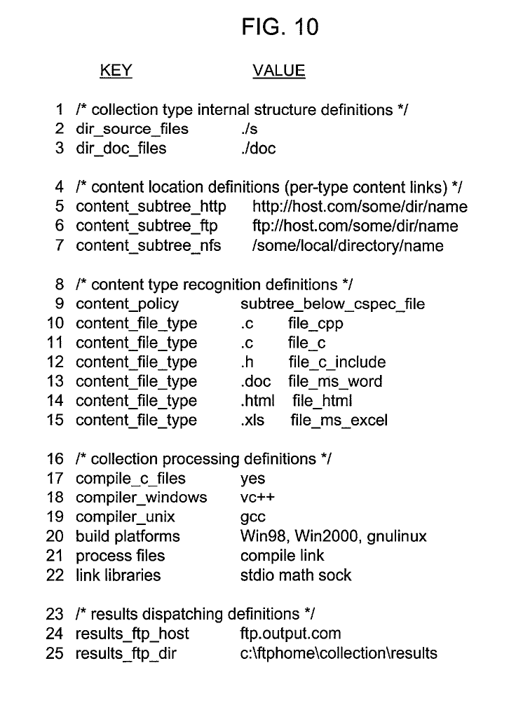

FIG. 9 shows an example collection type definition datastructure that could be used by application programs to process collections. Specific information content of a collection type definition datastructure is determined by implementation policy. However, collection type definitions typically contain information such as shown in FIGS. 9-10.

FIG. 10 shows example information content for a collection type definition datastructure such as shown in FIG. 9. FIG. 10 shows information concerning internal collection directory structures, collection content location definitions, collection content datatype definitions, collection processing definitions, and collection results processing definitions. The specific information content of a collection type definition is determined by implementation policy. If desired, more complex definitions and more complex type definition information structures can be used to represent more complex collection structures, collection contents, or collection processing requirements.

Work Situation Terminology

This section defines various terms that are used in this document.

Work situations are the unions of work purpose (why), work location (where), work object (what), work role (who), work timeset (when), work methods (how).

Work purposes (why) are represented by contexts in a Collection Knowledge System (see the related patent application at the beginning of this document).

Work locations (where) are working directories in a computer filesystem. Work locations are called base directories in this document, because they serve as a base of operations for a Collection Adaptive Focus GUI.

Work objects (what) are collections that are operated on by a Collection Adaptive Focus GUI.

Work roles (who) are sets of work operations that are made available by a Collection Adaptive Focus GUI. Roles are defined as sets of GUI operations, menu choices, buttons, and various other graphical user interface elements. Work roles allow human workers to access various sets of related work operations in a convenient, organized manner.

Work timesets are sets of time-dependent work situation values. Work timesets are means for changing work situations in particular ways at particular times. A Collection Adaptive Focus GUI adapts itself in accordance with work situation change events that are specified with timesets.

Work methods (how) are the means by which a Collection Adaptive Focus GUI carries out work operations. Typical work methods include GUI callback functions and parameterized command lines that are executed in spawned child execution processes that are outside of the main Adaptive Focus GUI thread of execution.

Work focus variables are key-value pairs that store parameter values for use in GUI work method (how) templates. Work method templates contain placeholder variable names that are replaced at runtime with values from corresponding focus variables. Focus variables allow one command template to be reused with many different variable values.

Work focus variable groups are sets of related focus variables that are managed as a single group. Usually members of a focus variable group are related by a common purpose.

Full Work Situations are work situations that are fully specified—that is, specific values are provided for a context (why), a base directory (where), a collection (what), a role (who), a timeset (when), and optionally, for focus variables and focus groups.

Partial Work Situations are situations that are not fully specified. One or more of the normal situation specifiers—a context, a base directory, a collection, a role, or a timeset—are omitted from the situation definition. Partial work situations must be expanded into full situations before they can be used to adapt a GUI to a new work situation.

Work Situation Change Events are computational signals that initiate changes to the current user work situation. For example, situation change events could be explicit requests to change to a new work situation, or to change a context, a base directory, a collection, a role, a timeset, a focus variable, or a focus variable group. Normally, change events are initiated by human working that click GUI menu choices or toolbar buttons. In contrast, time change events are initiated by the system clock, and do not require human input.

A Full Situation Change Event is an event that provides a full situation name in a work situation change event.

A Partial Situation Change Event is an event that requests a change in only one of the normal work situation specifiers (context, base directory, collection, role, timeset). Partial situation change events must be expanded into full situations before they can be used to adapt a GUI to a new work situation.

An Initial Invocation Change Event is the first change event in a user working session. When users first invoke an Adaptive Focus GUI, the GUI adapts itself according to the initial invocation change event. Typically the initial invocation change event requests the restoration of the most recently stored previous work situation, so that users can start their new session where they left off in their previous session.

A Loss Of Work Situation Focus occurs whenever a GUI adapts itself to a new work situation. A loss of focus occurs for the old work situation, and a gain of focus occurs for the new work situation.

Focus Gain Actions and Focus Loss Actions are performed when a Collection Adaptive Focus GUI changes from an old work situation to a new work situation. A Focus Loss Action is performed for the old work situation, and a Focus Gain Action is performed for the new work situation. Focus Actions can be implemented by internal function calls, external spawned commands, lists of menu choices, or by other executable computation methods known to the art.

An Adaptive Response is a set of adaptive actions executed in response to a work situation change event, to adapt a GUI to a new work situation. Adaptive actions may be internal (affecting only the GUI itself, or may be external (affecting the external runtime environment in some way, such as by manipulating files, by sending mail, or performing other actions external to the GUI program).

Adaptive Data is any data used to adapt a Collection Adaptive Focus GUI to a new work situation. Adaptive data typically includes work situation change event data, work situation data (including both full and partial situation data), GUI role and layout data, and GUI action data. Typically, adaptive data is stored in an Adaptive Data Storage Means.

An Adaptive Data Storage Means is a data storage means used to store adaptive data. Several specific means are possible, including ASCII files in a hierarchical computer filesystem, relational databases, and Collection Knowledge Systems. (For more information on Collection Knowledge Systems see the related patent applications at the beginning of this document.) Adaptive data storage means can be context-sensitive, which means that the same data query can produce different results, depending on the value of a context token provided in the query. Collection Knowledge Systems are context sensitive Adaptive Data Storage Means.

Collection Adaptive Focus GUI

A Collection Adaptive Focus GUI has four major components.

One component is a graphical user interface application framework, which provides software means for creating a particular GUI user interface. Software subroutines for constructing GUI interfaces are usually provided by the operating system.

A second component is a software means for receiving, interpreting, and adapting to work situation change events. This adaptive software component contains algorithms that distinguish a Collection Adaptive Focus GUI from other GUI applications.

A third component is a set of adaptive knowledge for specifying work situations, adaptation policies, and various corresponding GUI configurations. A store of adaptive knowledge contains custom, user-defined work situation information.

A fourth component is a storage mechanism for storing and managing adaptive knowledge information. This discussion contemplates an Adaptive Data Storage Means 121 to manage the adaptive knowledge.

The following discussion explains the overall architecture and operation of a Collection Adaptive Focus GUI.

Collection Adaptive Focus GUI Architecture

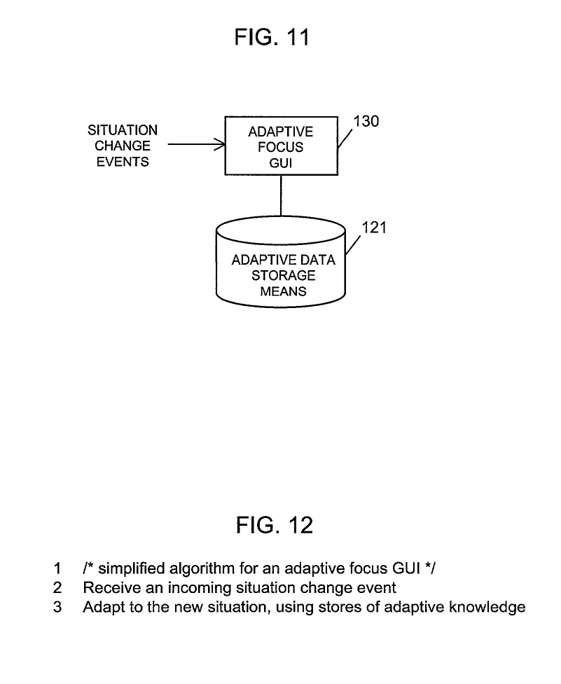

FIG. 11 shows a simplified architecture for a Collection Adaptive Focus GUI 130.

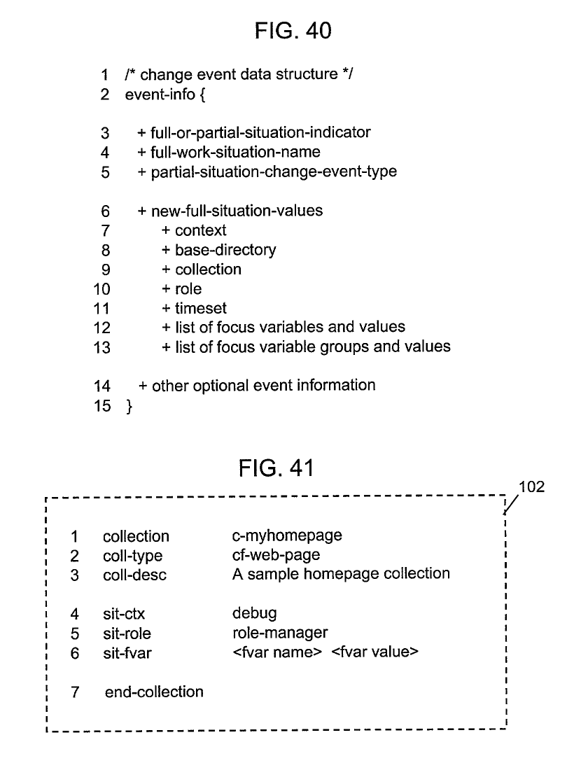

Module Adaptive Focus GUI 130 receives incoming work situation change events FIG. 40, and adapts its GUI interface in response.

Module Collection Knowledge System 121 stores adaptation knowledge in the form of policies that define how an Adaptive Focus GUI 130 should adapt to particular combinations of work situation change events.

In operation, Module Adaptive Focus GUI 130 proceeds according to the simplified algorithm shown in FIG. 12.

First, Module Adaptive Focus GUI 130 receives and interprets a work situation change event. Second, it adapts its GUI interface in accordance with adaptation policies and information stored in Collection Knowledge System 121.

Module Adaptive Response Manager

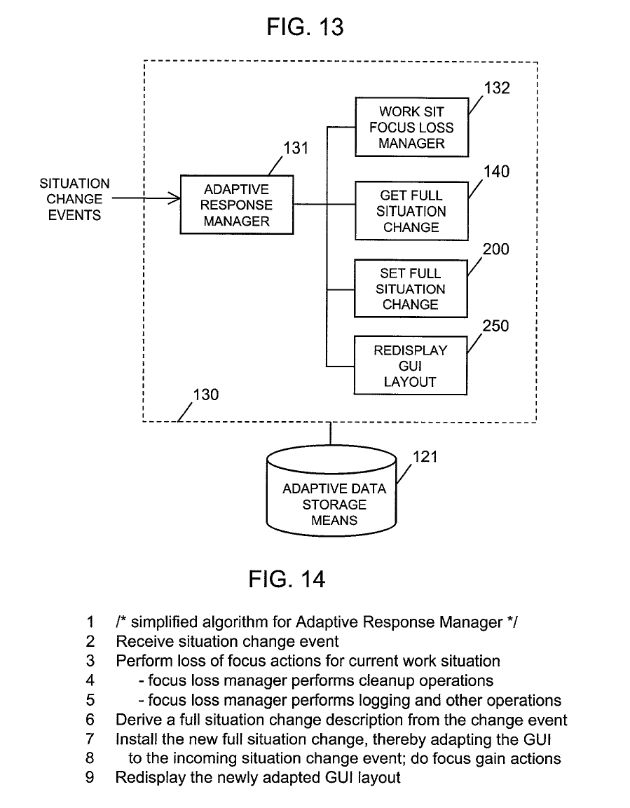

FIG. 13 shows a simplified architecture for an Adaptive Response Manager 131.

Module Adaptive Response Manager 131 oversees the interpretation of work situation change events and adaptive GUI responses that are specified by adaptation policy knowledge.

Module Work Situation Focus Loss Manager 132 performs adaptive actions in response to loss of focus on the current work situation, which is caused by incoming work situation change events.

Module Get Full Situation Change 140 interprets incoming work situation change events, and in response, produces new full work situation definitions in accordance with stored adaptation knowledge.

Module Set Full Situation Change 200 implements the required adaptive response (the new work situation) by calculating new GUI operational and display parameters (e.g. new menus, toolbars, working directories, and so on).

Module Redisplay GUI Layout 250 completes the adaptive response by displaying the new GUI layout (menus, buttons, etc) on a computer display screen.

Operation

In operation, Adaptive Response Manager 131 proceeds according to the simplified algorithm shown in FIG. 14.

First, Adaptive Response Manager 131 passes an incoming work situation change event FIG. 40 to Module Work Situation Focus Loss Manager 132, which performs useful focus loss actions required by the GUI as GUI focus is lost from the current work situation and is subsequently gained by a new work situation.

Focus loss actions such as cleanup actions or logging actions could include internal data structure manipulations, updating visible GUI labels with loss of focus indications, or saving current work situation data to external files or databases. Logging actions could include logging the change in focus, saving or logging data from the old and new work situations involved, or logging other interesting data such as the time of the change, the user involved, or other interesting information.

Next, Adaptive Response Manager 131 passes the incoming work situation change event to Module Get Full Situation Change 140 for interpretation. In response, Module Get Full Situation Change 140 produces a new full situation definition that specifies an appropriate adaptive response to the incoming change event.

Next, Adaptive Response Manager 131 passes the new full situation definition to Module Set Full Situation Change 200. This module uses the new full work situation to replace the existing GUI layout configuration with a new layout configuration, thereby adapting the GUI to the new work situation. Focus gain actions such as logging are also performed by Module Set Full Situation Change 200.

Finally, Adaptive Response Manager 131 calls Module Redisplay GUI Layout 250 to update the physical computer screen on which the Adaptive Focus GUI 130 is displayed, thereby offering human workers a new set of work events and work operations specifically chosen for the new work situation.

Module Get Full Situation Change

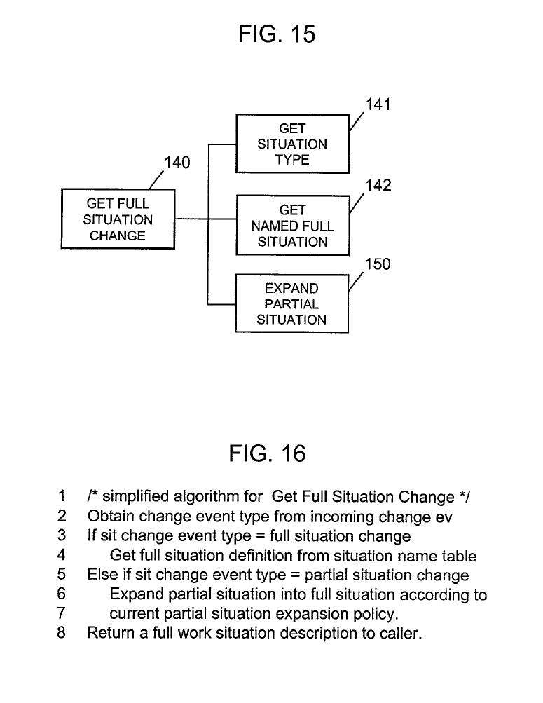

FIG. 15 shows a simplified architecture for Module Get Full Situation Change 140.

Module Get Full Situation Change 140 interprets incoming work situation change events, and in response, produces a new full work situation definition that describes the desired adaptive GUI response to the incoming change event.

Module Get Situation Change Type 141 determines a change event type for an incoming change event. The type value can indicate either a full work situation change event or a partial work situation change event.

Module Get Named Full Situation 142 uses incoming work situation change event data to obtain a desired target full situation name, and to return a named, full situation definition.

Module Expand Partial Situation Policy 150 uses an incoming partial work situation change event and a partial work situation policy definition to expand the partial work situation change event into a full work situation definition.

In operation, Module Get Full Situation Change 140 proceeds according to the algorithm shown in FIG. 16.

Module Get Situation Change Type 141 is called to determine if the incoming change event represents a named full work situation change event, or if it represents a partial work situation change event.

If the incoming change event is for a change to a new full situation by name, Module Get Full Situation Change 140 passes the incoming situation name to Get Named Full Situation 142 for conversion into a full work situation definition. Get Named Full Situation 142 first obtains a full situation name from the incoming change event. Next, it looks up the obtained full situation name in a situation name table, obtains a full situation definition file, and returns a corresponding full situation definition from the obtained full situation definition file.

Situation Name Table

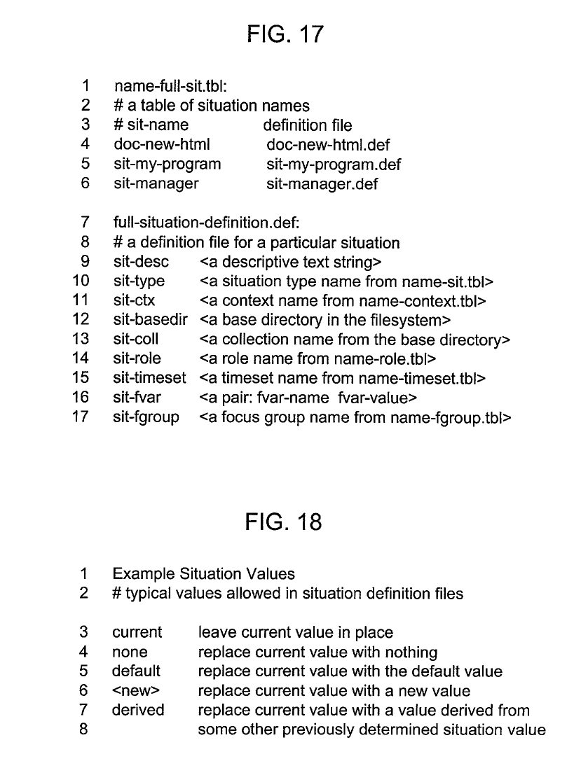

FIG. 17 shows a situation name table Lines 1-5 and a symbolic description of a full situation definition Lines 7-17. FIG. 18 shows various possible situation values that can be used in situation definition files.

Recall that full situation definitions are comprised of the union of a context value (contexts are further described in the related patent application, Collection Knowledge System), a base directory value, a collection value, a role value, a timeset value. Optionally, multiple focus variable and focus group definitions may also be included in full situation definitions.

FIG. 17 Line 9 provides a one-line documentation string for user convenience. Line 10 defines the situation type, which is explained in a section below. Line 11 defines a situation context value, for performing data lookups in a Collection Knowledge System 121. Line 12 defines a situation base directory—a working directory—for an Adaptive Focus GUI. Line 13 defines a situation collection name to specify the default target collection of Adaptive Focus GUI commands. Line 14 defines a situation role, which specifies a particular set of work operations to be made accessible through a Collection Adaptive Focus GUI interface. Line 15 defines a situation timeset, which specifies various Adaptive Focus GUI adaptations that should be carried out at particular times.

FIG. 17 Line 16, if present, defines an optional focus variable (a key-value pair) for use in performing substitutions into Adaptive Focus GUI menu choice templates FIG. 33. At command execution time, focus variable names in work operation command templates are replaced with corresponding focus variable values, to produce executable commands. Similarly, FIG. 17 Line 17, if present, defines a group of focus variables for use in performing command substitution operations.

Situation Definitions

In operation, any module that performs a lookup operation using a name table and corresponding definition files must proceed in two steps. First, a symbolic name token is used as a lookup key into Column 1 of a name table, to obtain a definition filename from Column 2 of the name table. Second, the definition filename value is used to locate a complete definition for the original name value. Readers should realize that this sequence is specific to name tables; other data storage methods such as relational databases are possible, and would use lookup sequences that are different than the lookup sequences described here for name tables.

Returning now to the operation of Module Get Named Full Situation 142, it obtains a desired full situation name from the incoming change event, and looks up the name in Column 1 of a name table FIG. 17 Lines 1-6. Supposing that the new situation name was “sit-my-program”, Get Named Full Situation 142 would find a match on Line 5, and would thus obtain a definition filename of “sit-my-program.def”.

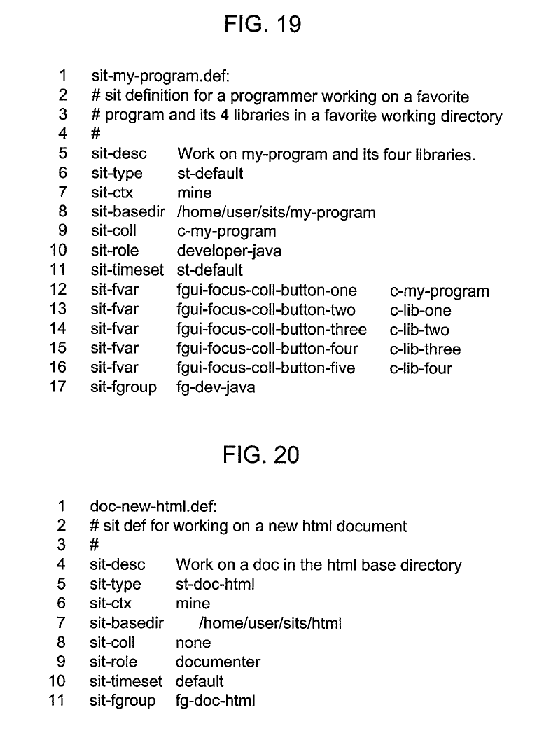

FIG. 19 shows a definition file “sit-my-program.def” for the situation named “sit-my-program” on FIG. 17 Line 5. This definition describes a situation for a programmer who wants to work on a main program collection and its four associated library collections. Lines 6-11 define the mandatory values for a full situation; Lines 12-17 define optional focus variables and focus groups.

As a practical example of useful adaptation, note that FIG. 19 Lines 12-17 associate specific GUI toolbar buttons with each of the program and library collections that are part of the situation. Associating collections with buttons makes it easy for programmers to switch GUI work situations among a set of collections simply by pressing toolbar buttons.

FIG. 20 shows another example situation definition file. This time, the definition file is for creating a new HTML document in a working directory where new HTML documents are created.

To complete its function in this example, Module Get Named Full Situation 142 would pass the full situation definition from FIG. 19 back to its caller, Module Get Full Situation 140.

Full Work Situations

The purpose of full work situations is to model human work circumstances. So in practice, human workers would define custom work situation definitions for each of their habitual work situations.

After defining custom work situations, human workers could easily switch among them by using GUI menus or toolbar buttons to initiate situation change events. In response, an Adaptive Focus GUI would modify visible GUI menus and toolbar buttons to support the new work situations.

Thus a Collection Adaptive Focus GUI interface can provide human workers with an optimal set of work operations for their custom work situations.

Situation Types

Situation types are a means for sharing default values among situation definition files. Sharing values is useful because it reduces knowledge maintenance costs and makes it easier to create sets of similar work situations definitions.

As one example of sharing, if a programming site has only one project to work on, then most situations will share the same base directory for the project. As second example, if a programmer always works as a programmer, and never as a manager or a documenter or web developer, then all of the relevant work situations will share the same programmer role. A third example of sharing would be a site policy that required all work situations to use a particular set of company focus variables.

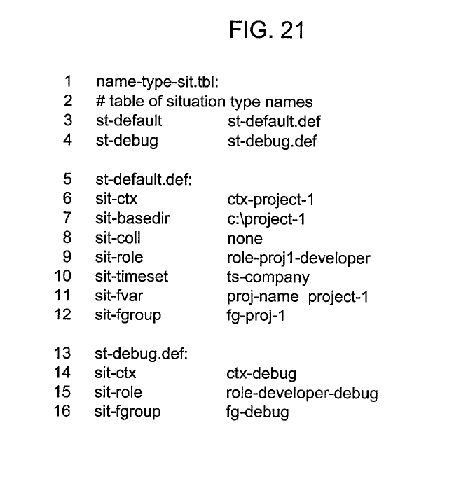

FIG. 21 shows a situation type name table Lines 1-4, and two situation type definition files Lines 5-12 and Lines 13-16.

In operation, situation type definitions are used to define situation values that are not completely defined by named full situation definitions. For example, consider the named situation definition described eariler in FIG. 19, “sit-my-program.def”. FIG. 19 Line 11 defines the value “st-default” for the situation timeset. The value “st-default” means that a corresponding shared value from a situation type must be used as the actual timeset value.

Continuing, Get Named Full Situation 142 reads FIG. 19 Line 11, obtains the value “st-default” from Column 2, and recognizes that the “st-default” value must be replaced with a value from a situation type definition.

Get Named Full Situation 142 continues by using the situation type value “st-default” FIG. 19 Line 11 as a lookup key into a situation type name table FIG. 21 Line 3. Column 2 provides the definition filename “st-default.def,” which is shown by FIG. 21 Lines 5-12. Finally, Get Named Full Situation 142 looks up the type definition timeset value FIG. 21 Line 10, and obtains the desired timeset value “ts-company” to use in the original situation definition file FIG. 19 Line 11.

Situation types make it possible for sites to share common values among all situation definitions at a site; they also reduce knowledge maintenance costs because only one copy of each shared situation type value must be maintained.

Module Set Full Situation

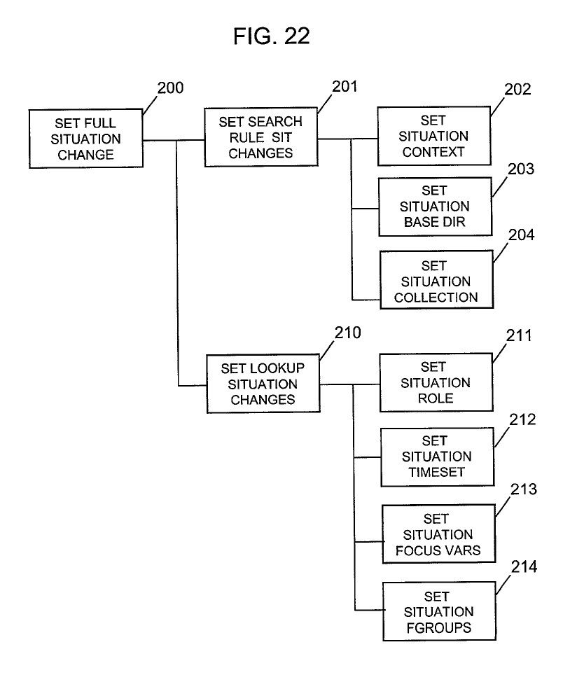

FIG. 22 shows a simplified architecture for Module Set Full Situation Change 200.

Module Set Search Rule Situation Changes 201 implements situation change values that affect search rules formulated by an underlying Collection Knowledge System 121.

Module Set Situation Context 202 implements a new situation context by changing the internal context value that is used by a Collection Adaptive Focus GUI to perform knowledge lookups in an underlying Collection Knowledge System 121.

Module Set Situation Base Directory 203 implements a new situation base directory by changing the current working directory of a Collection Adaptive Focus GUI.

Module Set Situation Collection 204 implements a new situation collection by changing the current internal collection name used by a Collection Adaptive Focus GUI, thereby making the new collection the default target of GUI commands and work operations.

Module Set Lookup Situation Changes 210 implements situation changes that use lookups to obtain new situation values. In general, these kinds of situation changes use situation change values as lookup keys into a Collection Knowledge System 121, in order to obtain additional information for adapting a GUI to a new situation.

Module Set Situation Role 211 implements a new situation role value by changing the current internal role value, and by performing a lookup on the new role name to obtain further role information from a role definition file.

Module Set Situation Timeset 212 implements a new situation timeset by changing the current internal timeset value, and by performing a lookup on the new timeset name to obtain further timeset information from a timeset definition file.

Module Set Situation Focus Variables 213 implements focus variable settings for a new situation by defining new focus variable names and values, or by overwriting old values for known focus variable names.

Module Set Situation Focus Groups 214 implements focus variable group settings for a new situation by defining new groups of focus variable names and values, or by overwriting old values for known focus variable names. Focus variable groups are named groups of focus variables that have been grouped together for user convenience.

Operation

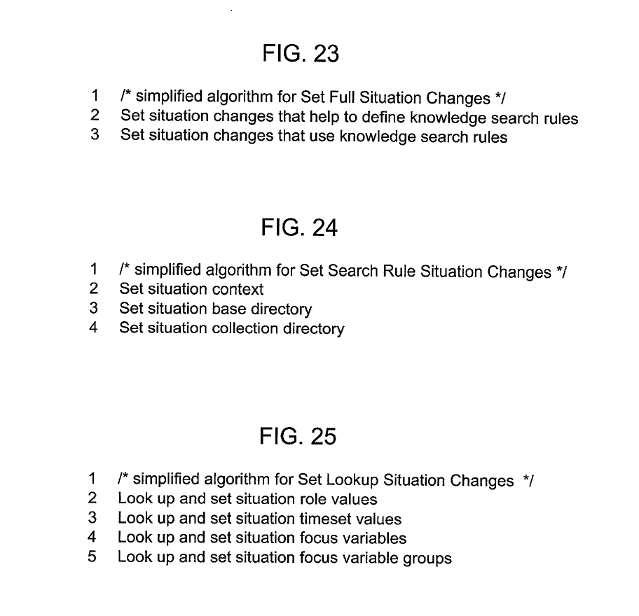

In operation, Module Set Full Situation Change 200 proceeds according to the algorithms shown in FIG. 23 to FIG. 25.

First, Module Set Full Situation Change 200 calls Module Set Search Rule Situation Changes 201 to implement new situation changes that affect the search rules used by an underlying Collection Knowledge System 121. Module Set Search Rule Situation Changes 201 proceeds according to the algorithm shown in FIG. 24.

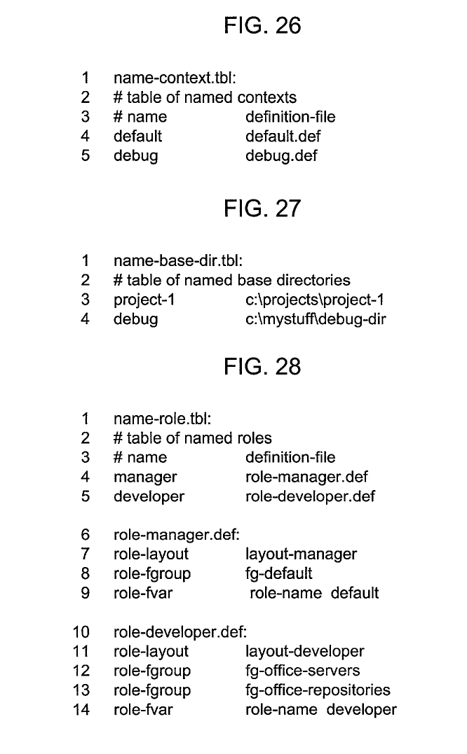

Module Set Situation Context 202 uses the incoming context name as a lookup key into Column 1 of a context name table FIG. 26, to ensure that the incoming context name is valid. If a match is found, the incoming context name is stored in an internal GUI variable. If no match is found, the incoming context name is invalid, and is rejected.

Module Set Situation Base Directory 203 uses the incoming base directory token as a lookup key into Column 1 of a base directory name table FIG. 27. If a match is found, the corresponding physical filesystem directory from Column 2 is used as the new physical base directory. If no match is found, the incoming base directory token is treated as a physical directory pathname. Module Set Situation Base Directory 203 completes its function by making an operating system subroutine call to change the current working directory of the GUI.

Module Set Situation Collection 204 inspects the current base directory for a collection name that matches the incoming collection name. If a match is found, the incoming collection name is stored in an internal GUI variable. If no match is found, the incoming value is rejected.

Second, Set Full Situation Change 200 calls Module Set Lookup Situation Changes 210 to oversee implementation of the remaining new situation changes. Module Set Lookup Situation Changes 210 proceeds according to the algorithm shown in FIG. 25.

Module Set Situation Role 211 uses the incoming role name as a key to perform a lookup in a role name table FIG. 28 Lines 1-5. If a match is found, the incoming role name is stored in an internal GUI variable; otherwise the incoming role name is rejected. In addition, data from a corresponding role definition file such as FIG. 28 Lines 6-9 or FIG. 28 Lines 10-14 is loaded into the GUI for further use in adapting the GUI to the new situation. In particular, role definitions specify GUI layouts FIG. 28 Lines 7, 11 that are used to adapt the GUI to the incoming situation.

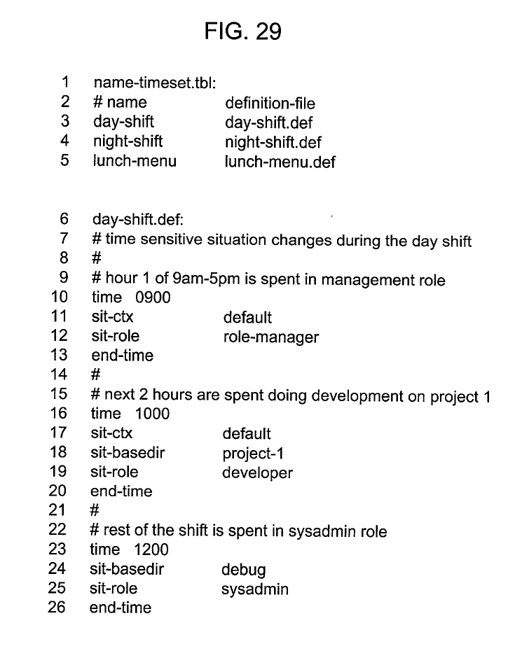

Module Set Situation Timeset 212 uses the incoming timeset name as a key to perform a lookup in a timeset name table FIG. 29 Lines 1-5. If a match is found, the incoming timeset name is stored in an internal GUI variable; otherwise it is rejected. In addition, data from a corresponding timeset definition file such as FIG. 29 Lines 6-26 is loaded into the GUI for further use in adapting the GUI to the new situation.

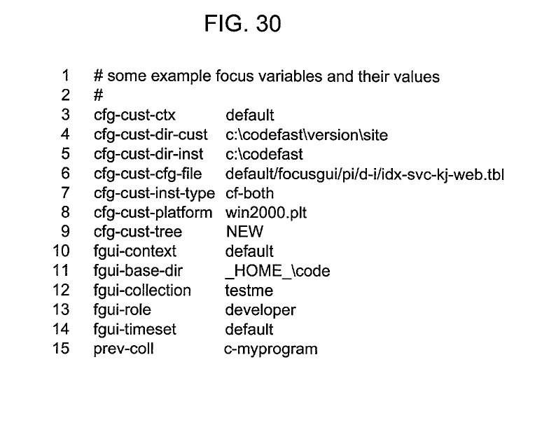

Module Set Situation Focus Variables 213 uses incoming focus variable names and values to set the values of internal focus variables within the GUI. FIG. 30 shows examples of some typical focus variables and their values. User-defined focus variables are possible; users can define whatever focus variables they need in order to support user-defined GUI command templates.

FIG. 33 shows an example GUI menu choice definition that uses a focus variable substitution technique to dynamically construct an operating system shell command for later execution. In operation, when a menu choice is selected by a user, a Collection Adaptive Focus GUI substitutes the value of focus variables into command line templates such as shown in FIG. 33 Line 7, thereby forming a valid command line that can be executed to fulfill the function of the menu choice. FIG. 33 Line 7 specifies that the value of a focus variable named “filename” be substituted into the template in place of the “@{filename}” placeholder string.

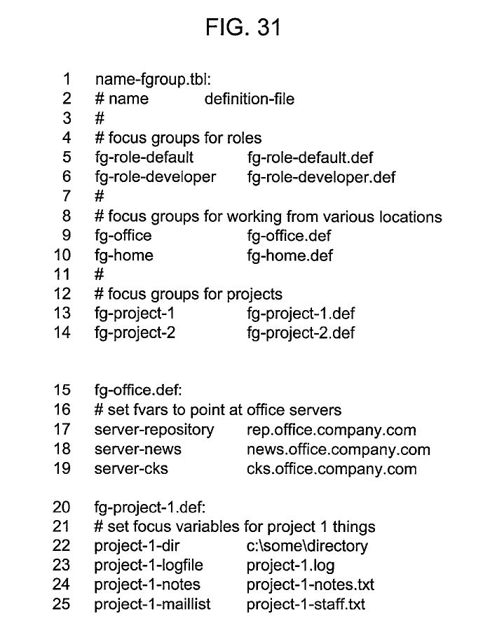

Module Set Situation Focus Groups 214 uses incoming focus group names as keys to perform lookups in a focus group name table FIG. 31 Lines 1-14. For each focus group name that is found, a corresponding focus group definition file such as FIG. 31 Lines 15-19 or Lines 20-25 is used to set focus variables and values.

This completes the description of how new situations are set by Module Set Full Situation Change 200. Discussion continues with an explanation of how new situation values are used to update the display of a Collection Adaptive Focus GUI.

Module Redisplay GUI Layout

After a new set of situation values has been set in place by Module Set Full Situation Change 200, Module Adaptive Response Manager 131 completes the GUI adaptation process by calling Module Redisplay GUI Layout 250 to update the GUI display layout. A GUI layout defines a set of menus, toolbars, and other GUI functions to be made available to users through a Collection Adaptive Focus GUI.

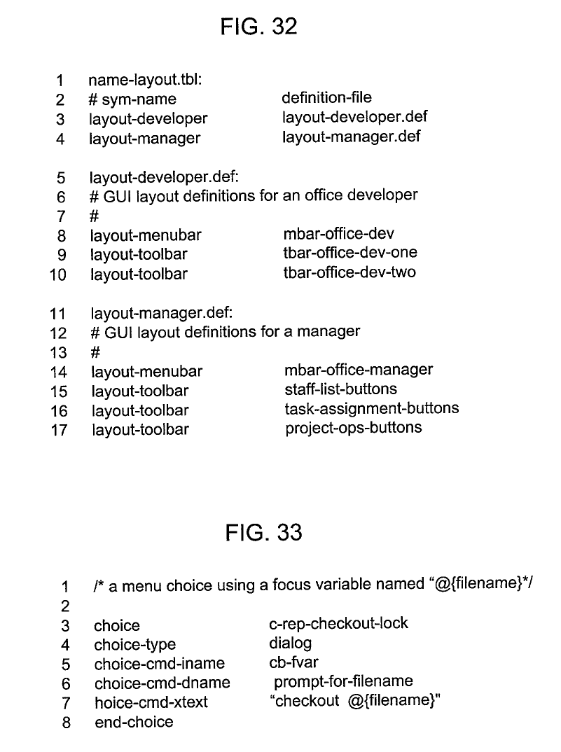

FIG. 32 shows a layout name table Lines 1-4 and an example layout definition file FIG. 32 Lines 5-10, and Lines 11-17.

Operation

In operation, Module Redisplay GUI Layout 250 obtains the name of a layout from a role definition file. For example, FIG. 28 Line 7 specifies that a layout named “layout-manager” be used for the “manager” role named on FIG. 28 Line 4 of the role name table.

Continuing, Module Redisplay GUI Layout 250 uses the layout name “layout-manager”as a key into Column 1 of a layout name table such as shown in FIG. 32. A key match occurs on FIG. 32 Line 4 in the layout name table, which specifies that a file named “layout-manager.def” is the layout definition file FIG. 32 Lines 11-17 for the “layout-manager” layout name. FIG. 32 Lines 14-17 in the layout definition specify the menubar and toolbars that comprise the layout.

Module Redisplay GUI Layout 250 reads information from the layout definition, dynamically constructs a new GUI layout, and updates the computer display screen with a corresponding new GUI layout. Details of constructing menus and toolbars are well described in the prior art, and so are not explained here.

This concludes the explanation of how a Collection Adaptive Focus GUI reacts to incoming full situation change events. Discussion now continues with partial situation change events. The main thing to remember about partial situation change events is that the main goal is to expand them into full situation descriptions; then they are treated identically to the full situations that were described above.

Partial Situation Changes

A Partial Situation Change Event is an event that requests a change in only one of the normal work situation specifiers. For example, a GUI user might want to change only the base directory, or only the collection, or only the role within a current work situation.

The main problem posed by partial situation change events is to determine which GUI adaptations should be made in response to the partial change event. The essential problem is determining how to calculate a full situation change event from a partial situation change event, according to local policies for performing such transformations.

Once a full situation change has been calculated, it is implemented identically to the full work situations that were described previously.

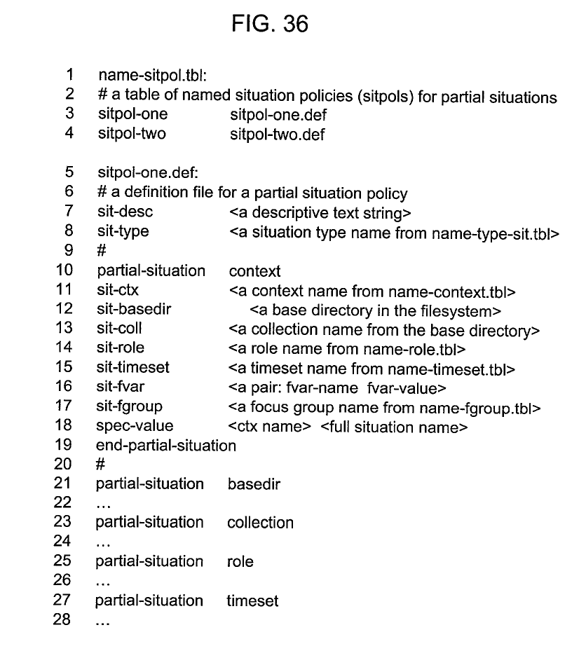

Partial Situation Policies are policies that describe how to expand a partial situation change event into a full situation change event. Partial situation policies are implemented by situation policy name tables FIG. 36 Lines 1-4 and situation policy definition files FIG. 36 Lines 5-28 that describe user-defined expansions.

Partial Situation Policy Definitions

FIG. 36 shows a partial situation policy name table Lines 1-4, and an example partial situation policy definition file Lines 5-28.

FIG. 36 Line 7 specifies a line of text that describes the policy. Line 8 specifies a situation type that can be used to fill in default situation values, as described previously. Lines 10, 21, 23, 25, and 27 are the starting lines of partial situation blocks.

Partial Situation Blocks are contained within partial situation policy definition files. A 1-to-1 association exists between partial situation blocks and major situation values. There are five major values—context, base directory, collection, role, timeset—so there are five partial situation blocks in a situation policy definition file. For each kind of incoming partial situation change event, an corresponding partial situation block is used to expand the partial event into a full situation.

For example, FIG. 36 Line 10 Column 2 contains the token “context,” so the block beginning on Line 10 specifies expansion policies for partial situation context change events. Similarly, the Line 21 block specifies information for base directory changes, the Line 23 block for collection changes, the Line 25 block for role changes, and the Line 27 block for timeset changes.

Most of the lines in partial situation blocks are identical to lines used in full situation definitions. For example, the partial situation block FIG. 36 Lines 11-17 are the same as the full situation lines in FIG. 17 Lines 11-17.

Only one special line is not the same. FIG. 36 Line 18 installs a named full situation if specific matching values of partial changes are detected; this specific mechanism will be described in a later section below.

There are three methods of expanding partial situations into full situations: using specific partial situation values, using normal partial situation values, and using derived situation values. Expansion using specific values is the simplest method, so it will be discussed first.

Expansion Using Specific Values

Expansion using specific values is a convenient mechanism for associating an incoming change value—such as a specific base directory or collection—with a previously defined, named, full situation. Making these associations is a useful thing to do because it promotes reuse of existing full situation definitions.

For example, suppose that all users require the “role-manager” GUI role whenever they work in a particular filesystem directory called “manager-info”. Then it would make sense to define a partial situation policy to implement this behavior. That is, whenever GUI users changed into the special base directory “manager-info”, a Collection Adaptive Focus GUI would switch to the GUI “role-manager” role.

FIG. 36 Line 18 shows how a specific context value can be associated with a full situation name. Column 1 contains the token “spec-value,” which stands for “specific value.” Column 2 is the specific value to match. Column 3 is a full situation name that can be found in a full situation name table FIG. 17.

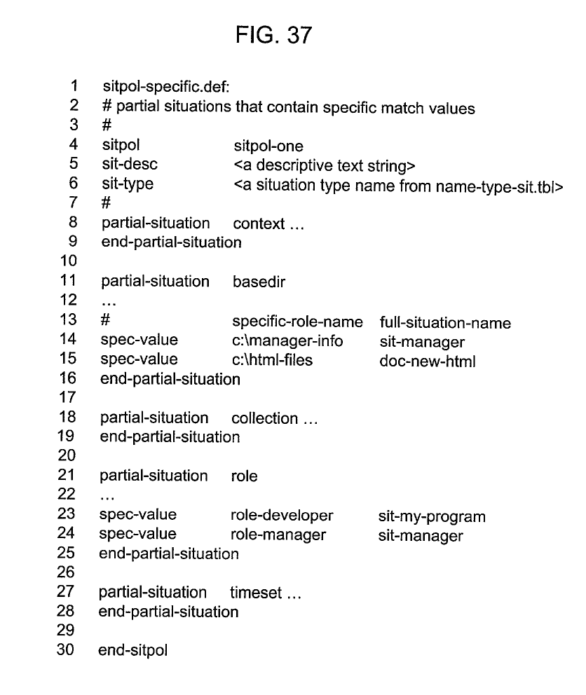

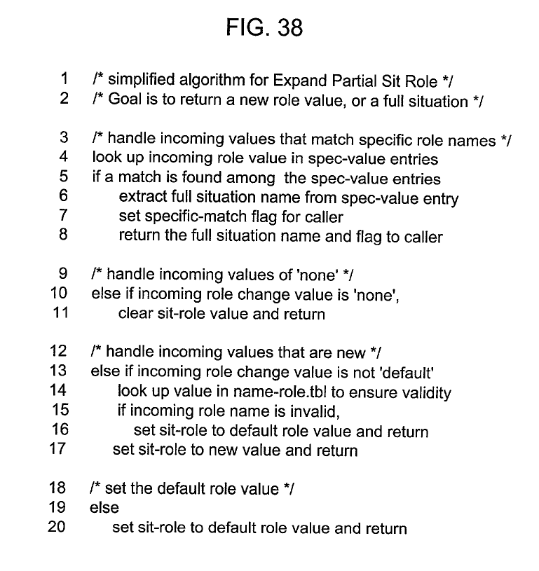

FIG. 37 shows several examples of specific value matches for base directories Lines 14-15 and roles Lines 23-24. As one example, FIG. 37 Line 14 specifies that whenever an incoming partial situation change calls for changing to directory “c:\manager-info”, the partial situation change should be immediately expanded to the full situation named “sit-manager” named in FIG. 17 Line 6. As a second example, FIG. 37 Line 24 specifies that whenever an incoming partial situation change calls for changing the role to “role-manager”, the partial situation change should be immediately expanded to the full situation named “sit-manager” FIG. 17 Line 6.

Expansion Using Normal Values

A second way of expanding partial situations is to create a new full situation by assembling individual situation values, one by one.

During normal expansion, one value is always known—the incoming change value that triggered the partial situation change. The other four values required to create a full situation must be determined using an appropriate partial situation block such as shown in FIG. 36 Lines 10-19.

In operation, a full situation is created by augmenting the incoming partial situation value with other values obtained from the partial situation block associated with the incoming partial situation value. As can be seen from FIG. 36 Lines 11-17, the format of a partial situation block is identical to that of full situation definitions as shown in FIG. 17 Lines 11-17.

Full situations are constructed identically in both cases, with the exception that partial situation expansion obtains one value from the incoming partial situation change event. In contrast, all situation values are defined by full situation definition files such as shown in FIG. 17 Lines 7-17.

FIG. 18 shows a table of possible situation values that can appear in partial situation blocks and in full situation definitions.

Expansion Using Derived Values

The main idea behind derived values is to automatically determine some situation values from previously set situation values. Derived situation values are a mechanism for creating chains of related situation values.

For example, suppose that it was desirable to set a “role-manager” situation role value whenever users worked on a collection of type “manager-info.” Then it would make sense to define a partial situation expansion policy that derived a role value “role-manager” from a collection type value of “manager-info.”

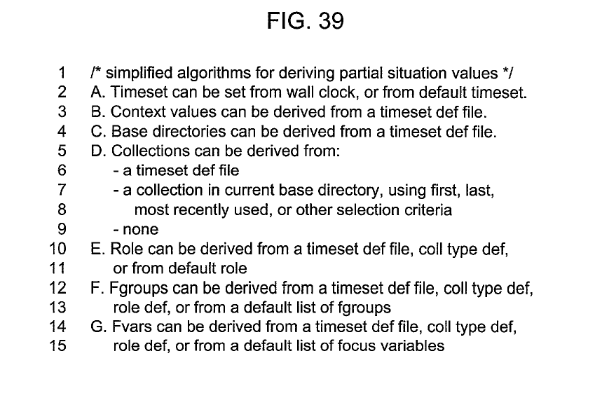

FIG. 39 shows a simplified algorithm for deriving various situation values from other situation values. In general, a derived situation value is obtained from a type definition file associated with a previously set situation value.

For example, suppose a timeset definition required that a particular context value and a particular role be set into place at a particular time (0900 hours). FIG. 29 Lines 11-12 show how such a policy goal could be achieved. Specifying derived values for other situation values is achieved in a similar way.

Timeset definition files can specify derived context, basedir, collection, role, focus variable, and focus group values. Collection type definition files can specify derived role, focus variable, and focus group values. Role definition files can specify derived focus variable and focus group values. Context, base directory, focus variable, and focus group values are not used to derive other situation values, because they currently have no definition or type definition files in which to store derived value information. Implementing definition files for these situation values would remove the limitation.

This concludes the description of how partial situations are expanded into full situations. Discussion now continues with the operation of the expansion process.

Module Expand Partial Situation

Module Expand Partial Situation 150 is called by Module Get Full Situation Change 140 if the incoming change event represents a partial work situation change event, and not a change to a named full situation. In such a case, the incoming partial work situation change event must be expanded into a full situation definition by Module Expand Partial Situation 150.

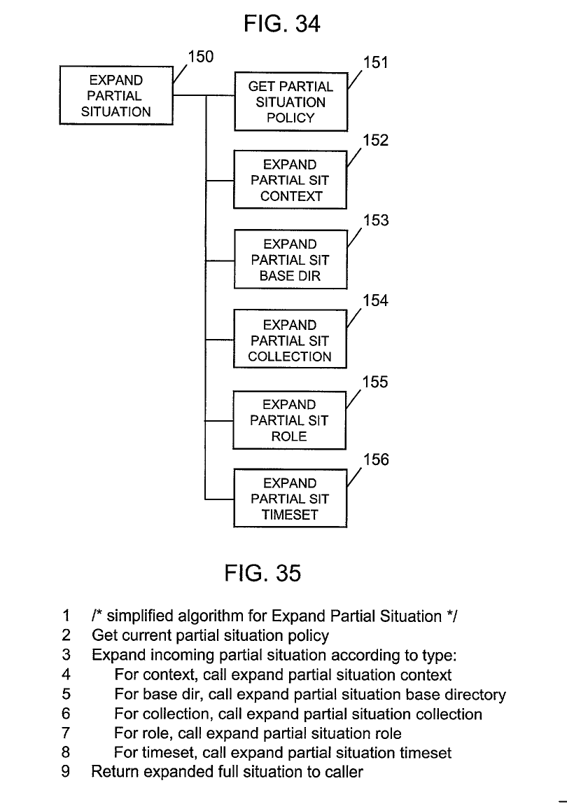

FIG. 34 shows a simplified architecture for Module Expand Partial Situation 150.

Module Get Partial Situation Policy 151 first obtains the current partial situation policy by looking up the current partial situation policy name in a situation policy name table FIG. 36 Lines 1-4 to obtain a partial situation policy definition file FIG. 36 Lines 5-28.

The current partial situation policy name is a configuration attribute of a Collection Adaptable Focus GUI, and is normally read from an initialization file containing initial configuration options at GUI invocation time. Changing the current partial situation policy name is possible; the new policy name replaces the old policy name in internal GUI variables, and may be saved in a current preferences file.

Module Expand Partial Situation Context 152 calculates a new full situation from an incoming context value.

Module Expand Partial Situation Base Directory 153 calculates a new full situation from an incoming base directory value.

Module Expand Partial Situation Collection 154 determines a new full situation from an incoming collection value.

Module Expand Partial Situation Role 155 calculates a new full situation from an incoming role value.

Module Expand Partial Situation Timeset 156 determines a new full situation from an incoming timeset value.

Each of the expansion modules 152-156 can use one of the three expansion techniques that are described below: specific value expansion, normal value expansion, or derived value expansion.

Operation

In operation, Module Expand Partial Situation 150 proceeds according to the algorithm shown in FIG. 35.

First, Module Expand Partial Situation 150 calls Module Get Partial Situation Policy 151 to obtain a policy definition file for expanding the incoming partial situation change event into a full situation.

Module Get Partial Situation Policy 151 obtains the current partial situation policy name from the GUI runtime environment using a prior art mechanism such as a configuration file, an environment variable, or a user-defined GUI variable.

Next, the module looks up the current partial situation policy name in a partial situation policy name table, to obtain a partial situation policy definition file such as shown in FIG. 36 Lines 5-28.

Next, the module selects a partial situation block to match the incoming type of change (context, base directory, collection, role, timeset). For example, using the partial situation blocks shown in FIG. 36, the block beginning at Line 10 would be selected for incoming context changes, the block at Line 21 for base directory changes, and so on. The selected block is passed back to the calling module Expand Partial Situation 150 for further use.

Continuing, Module Expand Partial Situation 150 now calls a corresponding subordinate module to expand the incoming partial change into a full situation change. To perform the expansion, the called subordinate module uses the partial situation policy block that was previously selected by Module Get Partial Situation Policy 151.

Module Expand Partial Situation Context 151 receives an incoming context value, and uses a partial situation block such as the one starting on FIG. 36 Line 10 to calculate and return a new full situation.

Module Expand Partial Situation Base Directory 152 receives an incoming base directory value, and uses a partial situation block such as the one starting on FIG. 36 Line 21 to calculate and return a new full situation.

Module Expand Partial Situation Collection 153 receives an incoming collection value, and uses a partial situation block such as the one starting on FIG. 36 Line 23 to calculate and return a new full situation.

Module Expand Partial Situation Role 154 receives an incoming role value, and uses a partial situation block such as the one starting on FIG. 36 Line 25 to calculate and return a new full situation.

Module Expand Partial Situation Timeset 155 receives an incoming timeset value, and uses a partial situation block such as the one starting on FIG. 36 Line 27 to calculate and return a new full situation.

Finally, Module Expand Partial Situation 150 receives the expanded partial work situation (now a full work situation definition), and passes it to Module Get Full Situation Change 140 for further use in adapting the GUI to the new work situation.

Situation Overrides Using Work Object Data

In addition to calculating work situation values from full situation definitions or from partial situation policies and partial situation change events, work situations can also be influenced by work situation values contained within work objects.

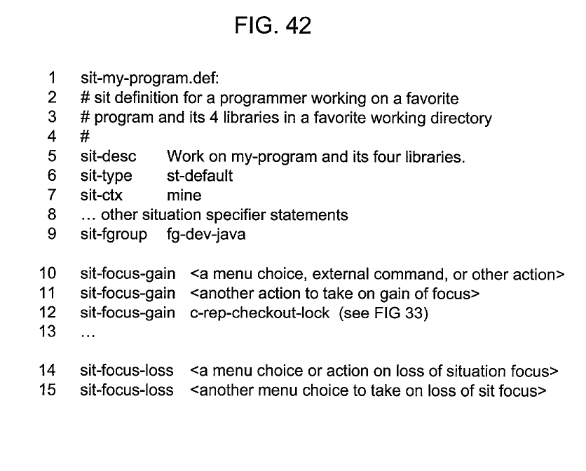

For example, FIG. 41 shows an example collection specifier that contains work situation value specifiers Lines 4-6 identical to those found in full situation definitions such as shown in FIG. 17.

Work situation value specifiers found inside specific collection specifier files FIG. 41 Lines 4-6 override work situation values obtained from other sources such as role, timeset, and focus variable definition files. This override convention provides users with a convenient means of asserting particular custom situation values for particular collections.

Without the ability to specify particular work situation values within a collection specifier 102, human workers are limited to using the work situation values that are normally calculated from collection type definition files.

Actions on Focus Gain or Loss

The main idea of focus gain and focus loss actions is to provide a means for specifying and executing useful actions at work situation tear down (focus loss) and set up (focus gain) times. For example, a GUI could send out time-stamped log events whenever a work situation lost or gained focus. From the log entries, statistics could be calculated on work situation usage, on the average time that work situations held focus, and so on.

FIG. 42 shows an example full situation definition file that specifies focus gain and focus loss actions. In particular, FIG. 42 Lines 10-15 specify lists of actions to be executed when focus on the FIG. 42 situation definition is gained or lost by a Collection Adaptive Focus GUI.

For example, the menu choice implementation “c-rep-checkout-lock” described in FIG. 33 could be specified as a focus gain action FIG. 42 Line 12 to be executed whenever the GUI changes to the “sit-my-program.def” work situation defined in FIG. 42.

Focus gain and focus loss actions can also be specified in situation type definitions, partial work situation policy definitions, in context definition files, in role definition files, in collection specifier files, and in timeset definition files.

For example, focus gain actions stored in collection specifier files could be executed when a GUI focused on the host collection, and focus-loss actions could be executed when a GUI changed from the collection to a new collection.

Further Advantages

As can be seen from the foregoing discussion, a Collection Adaptive Focus GUI can adapt itself to changes among multiple variant work situations. In particular, the Collection Adaptive Focus GUI invention described here is capable of responding to events that involve changes in purpose (why, context), location (where, base directory), work object (what, collection), work role (who, role), and chronological time (when, timeset). Thus a Collection Adaptive Focus GUI provides a practical and useful means for adapting and optimizing graphical user interfaces to changes in multiple variant work situations, a capability that was not previously known to the prior art.

Conclusion

The present Collection Adaptive Focus GUI invention provides practical solutions to thirteen important problems faced by builders of adaptive graphical user interfaces. The problems are these: (1) the overall Adaptive Focus GUI problem, (2) the Work Purpose Adaptation problem, (3) the Work Location Adaptation problem, (4) the Work Object Type Adaptation problem, (5) the Work Role Adaptation problem, (6) the Work Time Adaptation Problem, (7) the Work Method Adaptation Problem, (8) the Work Object Instance Adaptation Problem, (9) the Work Situation Focus Actions Problem, (10) the Partial Situation Expansion Problem, (11) the Customized Adaptation Data Problem, (12) the Sharable Adaptation Data Problem, and (13) the Scalable Adaptation Data Storage Problem.

As can be seen from the foregoing disclosure, the present Collection Adaptive Focus GUI invention provides human users with a practical means for precisely adapting their graphical user interfaces to specific work situations, using adaptation representations, models, and methods that were not previously available.

Ramifications

Although the foregoing descriptions are specific, they should be considered as example embodiments of the invention, and not as limitations. Those skilled in the art will understand that many other possible ramifications can be imagined without departing from the spirit and scope of the present invention.

General Software Ramifications

The foregoing disclosure has recited particular combinations of program architecture, data structures, and algorithms to describe preferred embodiments. However, those of ordinary skill in the software art can appreciate that many other equivalent software embodiments are possible within the teachings of the present invention.

As one example, data structures have been described here as coherent single data structures for convenience of presentation. But information could also be could be spread across a different set of coherent data structures, or could be split into a plurality of smaller data structures for implementation convenience, without loss of purpose or functionality.

As a second example, particular software architectures have been presented here to more strongly associate primary algorithmic functions with primary modules in the software architectures. However, because software is so flexible, many different associations of algorithmic functionality and module architecture are also possible, without loss of purpose or technical capability. At the under-modularized extreme, all algorithmic functionality could be contained in one software module. At the over-modularized extreme, each tiny algorithmic function could be contained in a separate software module.

As a third example, particular simplified algorithms have been presented here to generally describe the primary algorithmic functions and operations of the invention. However, those skilled in the software art know that other equivalent algorithms are also easily possible. For example, if independent data items are being processed, the algorithmic order of nested loops can be changed, the order of functionally treating items can be changed, and so on.

Those skilled in the software art can appreciate that architectural, algorithmic, and resource tradeoffs are ubiquitous in the software art, and are typically resolved by particular implementation choices made for particular reasons that are important for each implementation at the time of its construction. The architectures, algorithms, and data structures presented above comprise one such conceptual implementation, which was chosen to emphasize conceptual clarity.

From the above, it can be seen that there are many possible equivalent implementations of almost any software architecture or algorithm. Thus when considering algorithmic and functional equivalence, the essential inputs, outputs, associations, and applications of information that truly characterize an algorithm should be considered. These characteristics are much more fundamental to a software invention than are flexible architectures, simplified algorithms, or particular organizations of data structures.

Practical Applications

An Adaptive Focus GUI can be used in various practical applications.

One possible application is to improve the productivity of human knowledge workers, by providing them with a practical means for accessing work operations that are well-adapted to particular work situations that involve collections, spreadsheets, word processing documents, databases, web documents, or other project-file oriented applications.

Another application is to improve the usability of modern GUI interfaces by reducing the total number of visible GUI controls to an optimal set that is well-adapted to the current work situation.

Another application is to centralize the administration of work situation information within a community of users. One central store of full situation definitions, partial situation policies, and other adaptive knowledge can be accessed by many users through use of Adaptive Focus GUIs. This strategy shifts the burden of understanding and maintaining the knowledge from the many to the few.

Work Situation Change Events

The foregoing disclosure described change events as being initiated by humans using GUI controls such as menus or toolbar buttons, or by timeset events initiated by the system clock. However, other event sources and event restrictions are also possible.

Work situation change events can be generated and sent by other programs to an Adaptive Focus GUI. For example, a program that completes a processing action that is being monitored by an adaptive GUI could send a completion event to the GUI. In response, the adaptive GUI could provide users with a visual indication of program completion.

Work situation change events can also be restricted to be simpler than the full set of events described previously. For example, a simpler Adaptive Focus GUI could disallow events of one or more types, such as timeset events, or context events. This would simplify GUI implementation, at the cost of reduced functionality.

Situation Specifier Values

The foregoing discussion identified several possible sources of work situation value specifiers: full work situation definitions, partial work situation policies, three means of partial situation expansion, and work situation value specifiers contained within collection specifier instances FIG. 41 Lines 4-6.

However, other sources of value specifiers may also be used. For example, a GUI could obtain value specifiers by querying an external database or by communicating with a situation value server over a network.

Adaptive Knowledge Stores

The foregoing discussion identified an Adaptive Data Storage Means 121 as a preferred means for storing adaptation knowledge used by an Adaptive Focus GUI. However, other storage means are also possible.

For example, a relational database might be used to advantage, especially where large amounts of well-structured adaptive knowledge must be stored. As another example, a network adaptive knowledge server could provide adaptive knowledge to Collection Adaptive Focus GUIs, using a client-server protocol means. As a third example, adaptive knowledge might be stored and provided to GUIs using an XML markup language representation and a web server protocol such as HTTP.

Another important implementation of an Adaptive Data Storage Means 121 is a Collection Knowledge System, which contains internal knowledge search rules and client/server mechanisms useful for customization, sharing, and scalability. For more detailed information on Collection Knowledge Systems, see the related patent application “Collection Knowledge System” listed at the beginning of this document.

As can be seen by one of ordinary skill in the art, many other ramifications are also possible within the teachings of this invention.

Scope

The full scope of the present invention should be determined by the accompanying claims and their legal equivalents, rather than from the examples given in the specification.

I claim:

1. A Collection Adaptive Focus GUI process for adapting a graphical user interface to a new work situation, comprising the following steps:
(a) receiving a work situation change event, and
(b) performing an adaptive response to said work situation change event,
thereby providing a solution to the Adaptive Focus GUI Problem, and
thereby providing graphical user interfaces with a practical means for adapting themselves to changes in user focus and work situations, in a way that was not previously available.

2. The process of claim 1, wherein
(a) said step of receiving a work situation change event receives an event selected from the group consisting of initial invocation change events and full work situation change events and partial work situation change events and partial work situation context change events and partial work situation base directory change events and partial work situation collection change events and partial work situation role change events and partial work situation timeset change events and partial work situation focus variable change events and partial work situation focus variable group change events,
thereby helping to solve the Adaptive Focus GUI Problem, and
thereby helping to solve the Work Purpose Adaptation Problem, the Work Location Adaptation Problem, the Work Object Type Adaptation Problem, the Work Role Adaptation Problem, the Work Time Adaptation Problem, the Work Method Adaptation Problem, the Work Object Instance Adaptation Problem, and
thereby providing graphical user interfaces with a practical means for responding to work situation change events that represent the practical concepts of why, where, what, who, when, and how.

3. The process of claim 1, wherein
(a) said step of receiving a work situation change event receives a work situation change event from a source selected from the group consisting of human operators and external programs and a GUI program that is executing said step of receiving a work situation change event,
thereby helping to solve the Collection Adaptive Focus GUI Problem, and
thereby providing GUI interfaces with a practical means for responding to work situation change events that originate from both inside and outside the GUI program.

4. The process of claim 1, wherein
(a) said step of performing an adaptive response obtains a work situation name from said work situation change event,
thereby helping to solve the Collection Adaptive Focus GUI Problem, and
thereby providing a practical means for clearly identifying a particular work situation to be installed as part of said adaptive response.

5. The process of claim 1, wherein
(a) said step of performing an adaptive response uses a work situation name, and work situation data read from an adaptive data storage means, to perform a name matching operation to identify a work situation definition to be installed,
thereby helping to solve the Collection Adaptive Focus GUI Problem, and the Customized Adaptation Data Problem, and the Sharable Adaptation Data Problem, and the Scalable Adaptation Data Storage Problem,
and thereby providing a practical means for identifying a particular work situation definition to be installed as part of said adaptive response.

6. The process of claim 1, wherein
(a) said step of performing an adaptive response uses a work situation name, and work situation data read from a context-sensitive adaptive data storage means, to perform a name matching operation to identify a work situation definition to be installed,
thereby helping to solve the Collection Adaptive Focus GUI Problem, and the Customized Adaptation Data Problem, and the Sharable Adaptation Data Problem, and the Scalable Adaptation Data Storage Problem,
and thereby providing a practical means for identifying in a context-sensitive way a particular work situation definition to be installed as part of said adaptive response.

7. The process of claim 1, wherein
(a) said step of performing an adaptive response uses adaptive data read from an adaptive data storage means to perform said adaptive response,
thereby helping to solve the Collection Adaptive Focus GUI Problem, and the Customized Adaptation Data Problem, and the Sharable Adaptation Data Problem, and the Scalable Adaptation Data Storage Problem,
and thereby providing a practical means for obtaining adaptive data to be used in the performance of said adaptive response.

8. The process of claim 1, wherein
(a) said step of performing an adaptive response uses adaptive data read from a context-sensitive adaptive data storage means to perform said adaptive response,
thereby helping to solve the Collection Adaptive Focus GUI Problem, and the Customized Adaptation Data Problem, and the Sharable Adaptation Data Problem, and the Scalable Adaptation Data Storage Problem,
and thereby providing a practical means for obtaining in a context-sensitive way adaptive data to be used in the performance of said adaptive response.

9. The process of claim 1, wherein
(a) said step of performing an adaptive response performs zero or more focus-gain or focus-loss actions,
thereby solving the Work Situation Focus Actions Problem, and
thereby providing a practical means for performing useful focus-gain and focus-loss actions as the GUI changes from an old work situation to said new work situation.

10. The process of claim 1, wherein
(a) said step of performing an adaptive response uses adaptation information from definitions selected from the group consisting of context definitions and base directory definitions and collection type definitions and role definitions and timeset definitions and focus variable definitions and focus variable group definitions and GUI layout definitions and menu choice definitions,
thereby providing a practical means for utilizing stored adaptation knowledge to help solve the Collection Adaptive Focus GUI Problem, and
thereby helping to solve the Work Purpose Adaptation Problem, the Work Location Adaptation Problem, the Work Object Type Adaptation Problem, the Work Role Adaptation Problem, the Work Time Adaptation Problem, the Work Method Adaptation Problem, the Work Object Instance Adaptation Problem, and
thereby providing a practical means for utilizing scalable, extensible, customized, and user-provided adaptation knowledge to adapt a graphical user interface to specific user-oriented work situations in ways that were not previously available.

11. The process of claim 1, wherein
(a) said step of performing an adaptive response expands an incoming partial work situation change event into a full work situation,
thereby helping to solve the Adaptive Focus GUI problem, and
thereby providing users with a practical means for defining custom partial work situation expansion policies, and
thereby enabling users to focus on a new full work situation by providing only a convenient, partial work situation change event.

12. The process of claim 1, wherein
(a) said step of performing an adaptive response expands a partial work situation change event into a full work situation using an expansion method selected from the group consisting of specific value expansion methods and normal value expansion methods and derived value expansion methods,
thereby helping to solve the Adaptive Focus GUI problem, and
thereby providing users with several practical methods for expanding partial situation change events into full situations in accordance with desired user policy preferences.

13. The process of claim 1, wherein
(a) said step of performing an adaptive response overrides one or more full work situation values using work situation value specifiers contained within collection specifier instances,
thereby solving the Work Object Instance Adaptation Problem, and
thereby providing users with a practical means for associating particular work situation values with particular collection instances, and
thereby enabling users to conveniently override default work situation values that are defined by global site policies.

14. The process of claim 1, wherein
(a) said step of performing an adaptive response modifies internal GUI data values selected from the group consisting of context values and base directory values and collection values and role values and timeset values and focus variable values and focus variable group values,
thereby helping to solve the Adaptive Focus GUI problem, and
thereby helping to solve the Work Purpose Adaptation Problem, the Work Location Adaptation Problem, the Work Object Adaptation Problem, the Work Role Adaptation Problem, the Work Time Adaptation Problem, the Work Method Adaptation Problem, and
thereby providing a practical means for making work situation knowledge that is relevant to said new work situation available for use by internal GUI functions and externally-spawned command lines.

15. The process of claim 1, wherein
(a) said step of performing an adaptive response modifies one or more visible GUI layout components selected from the group consisting of menu bars and menus and menu choices and toolbars and status bars and text labels and list boxes and radio buttons and drop down boxes and GUI layout components,
thereby helping to solve the Adaptive Focus GUI problem by updating visible GUI displays and controls in accordance with said new work situation, and
thereby helping to solve the Work Purpose Adaptation Problem, the Work Location Adaptation Problem, the Work Object Adaptation Problem, the Work Role Adaptation Problem, the Work Time Adaptation Problem, the Work Method Adaptation Problem, and
thereby providing users with one or more visual indications of a GUI focus change from a previous work situation to said new work situation, and
thereby providing users with a new set of work operations that are relevant to said new work situation.

16. The process of claim 1, wherein
(a) said step of performing an adaptive response communicates adaptation results to one or more destinations selected from the group consisting of computer memories and computer display screens and computer files and computer networks,
thereby helping to solve the Collection Adaptive Focus GUI Problem,
and thereby providing a practical means for displaying and storing adaptation results as part of said adaptive response.

17. A programmable Collection Adaptive Focus GUI device for adapting a graphical user interface to a new work situation, whose actions are directed by software executing a process comprising the following steps:
(a) receiving a work situation change event, and
(b) performing an adaptive response to said work situation change event,
thereby providing a solution to the Adaptive Focus GUI Problem, and
thereby enabling graphical user interfaces to adapt themselves to changes in user focus and work situations in a scalable way that was not previously available.

18. The programmable device of claim 17, wherein
(a) said step of receiving a work situation change event receives an event selected from the group consisting of initial invocation change events and full work situation change events and partial work situation change events and partial work situation context change events and partial work situation base directory change events and partial work situation collection change events and partial work situation role change events and partial work situation time change events and partial work situation focus variable change events and partial work situation focus variable group change events,
thereby helping to solve the Adaptive Focus GUI Problem, and
thereby helping to solve the Work Purpose Adaptation Problem, the Work Location Adaptation Problem, the Work Object Type Adaptation Problem, the Work Role Adaptation Problem, the Work Time Adaptation Problem, the Work Method Adaptation Problem, the Work Object Instance Adaptation Problem, and
thereby enabling graphical user interfaces to respond to events corresponding to work situation change concepts of why, where, what, who, when, and how.

19. The programmable device of claim 17, wherein
(a) said step of receiving a work situation change event receives a work situation change event from a source selected from the group consisting of human operators and external programs and a GUI program that is executing said step of receiving a work situation change event,
thereby helping to solve the Collection Adaptive Focus GUI Problem, and
thereby providing GUI interfaces with a practical means for responding to work situation change events that originate from both inside and outside the GUI program.

20. The programmable device of claim 17, wherein
(a) said step of performing an adaptive response obtains a work situation name from said work situation change event,
thereby helping to solve the Collection Adaptive Focus GUI Problem, and
thereby providing a practical means for clearly identifying a particular work situation to be installed as part of said adaptive response.

21. The programmable device of claim 17, wherein
(a) said step of performing an adaptive response uses a work situation name, and work situation data read from an adaptive data storage means, to perform a name matching operation to identify a work situation definition to be installed,
thereby helping to solve the Collection Adaptive Focus GUI Problem, and the Customized Adaptation Data Problem, and the Sharable Adaptation Data Problem, and the Scalable Adaptation Data Storage Problem,
and thereby providing a practical means for identifying a particular work situation definition to be installed as part of said adaptive response.

22. The programmable device of claim 17, wherein
(a) said step of performing an adaptive response uses a work situation name, and work situation data read from a context-sensitive adaptive data storage means, to perform a name matching operation to identify a work situation definition to be installed,
thereby helping to solve the Collection Adaptive Focus GUI Problem, and the Customized Adaptation Data Problem, and the Sharable Adaptation Data Problem, and the Scalable Adaptation Data Storage Problem,
and thereby providing a practical means for identifying in a context-sensitive way a particular work situation definition to be installed as part of said adaptive response.

23. The programmable device of claim 17, wherein
(a) said step of performing an adaptive response uses adaptive data read from an adaptive data storage means to perform said adaptive response,
thereby helping to solve the Collection Adaptive Focus GUI Problem, and the Customized Adaptation Data Problem, and the Sharable Adaptation Data Problem, and the Scalable Adaptation Data Storage Problem,
and thereby providing a practical means for obtaining adaptive data to be used in the performance of said adaptive response.

24. The programmable device of claim 17, wherein
(a) said step of performing an adaptive response uses adaptive data read from a context-sensitive adaptive data storage means to perform said adaptive response,
thereby helping to solve the Collection Adaptive Focus GUI Problem, and the Customized Adaptation Data Problem, and the Sharable Adaptation Data Problem, and the Scalable Adaptation Data Storage Problem,
and thereby providing a practical means for obtaining in a context-sensitive way adaptive data to be used in the performance of said adaptive response.

25. The programmable device of claim 17, wherein
(a) said step of performing an adaptive response performs one or more focus-gain or focus-loss actions,
thereby solving the Work Situation Focus Actions Problem, and
thereby providing a practical means for performing useful focus-gain and focus-loss actions as the GUI changes from an old work situation to said new work situation.

26. The programmable device of claim 17, wherein
(a) said step of performing an adaptive response uses information from definitions selected from the group consisting of context definitions and base directory definitions and collection type definitions and role definitions and timeset definitions and focus variable definitions and focus variable group definitions and GUI layout definitions and menu choice definitions,
thereby providing a practical means for using stored adaptation knowledge to help solve the Collection Adaptive Focus GUI Problem, and
thereby helping to solve the Work Purpose Adaptation Problem, the Work Location Adaptation Problem, the Work Object Type Adaptation Problem, the Work Role Adaptation Problem, the Work Time Adaptation Problem, the Work Method Adaptation Problem, the Work Object Instance Adaptation Problem, and
thereby providing a practical means for utilizing scalable, extensible, customized, and user-provided adaptation knowledge to adapt a graphical user interface to specific user-oriented work situations in ways that were not previously possible.

27. The programmable device of claim 17, wherein
(a) said step of performing an adaptive response expands a partial work situation change event into a full work situation,
thereby helping to solve the Adaptive Focus GUI problem, and
thereby providing users with a practical means for defining custom partial work situation expansion policies, and
thereby enabling users to focus on a new full work situation by providing only a partial work situation change event.

28. The programmable device of claim 17, wherein
(a) said step of performing an adaptive response expands a partial work situation change event into a full work situation using an expansion method selected from the group consisting of specific value expansion methods and normal value expansion methods and derived value expansion methods,
thereby helping to solve the Adaptive Focus GUI problem, and
thereby providing users with several practical methods for expanding partial situation change events into full situations in accordance with desired user policy preferences.

29. The programmable device of claim 17, wherein
(a) said step of performing an adaptive response modifies internal GUI data values selected from the group consisting of context values and base directory values and collection values and role values and timeset values and focus variable values and focus variable group values,
thereby helping to solve the Adaptive Focus GUI problem, and
thereby helping to solve the Work Purpose Adaptation Problem, the Work Location Adaptation Problem, the Work Object Type Adaptation Problem, the Work Role Adaptation Problem, the Work Time Adaptation Problem, the Work Method Adaptation Problem, the Work Object Instance Adaptation Problem, and
thereby providing a practical means for making work situation knowledge that is relevant to said new work situation available for use by internal GUI functions and external spawned command lines.

30. The programmable device of claim 17, wherein
(a) said step of performing an adaptive response overrides one or more full work situation values using work situation value specifiers contained within collection specifier instances,
thereby solving the Work Object Instance Adaptation Problem, and
thereby providing users with a practical means for associating particular work situation values with particular collection instances, and
thereby enabling users to conveniently override default work situation values that are defined by global site policies.

31. The programmable device of claim 17, wherein
(a) said step of performing an adaptive response modifies one or more GUI layout components selected from the group consisting of menu bars and menus and menu choices and toolbars and status bars and text labels and list boxes and radio buttons and drop down boxes and GUI layout components affected by focus variables and focus variable groups,
thereby helping to solve the Adaptive Focus GUI problem by updating visible GUI displays and controls in accordance with said new work situation, and
thereby helping to solve the Work Purpose Adaptation Problem, the Work Location Adaptation Problem, the Work Object Adaptation Problem, the Work Role Adaptation Problem, the Work Time Adaptation Problem, the Work Method Adaptation Problem, and
thereby providing users with one or more visual indications of the focus change from a previous work situation to a new work situation, and
thereby providing users with a new set of work operations that are relevant to said new work situation.

32. The programmable device of claim 17, wherein
(a) said step of performing an adaptive response communicates adaptation results to one or more destinations selected from the group consisting of computer memories and computer display screens and computer files and computer networks,
thereby helping to solve the Collection Adaptive Focus GUI Problem,
and thereby providing a practical means for displaying and storing adaptation results as part of said adaptive response.

33. A computer readable memory, encoded with data representing a Collection Adaptive Focus GUI program that can be used to direct a computer when used by the computer, comprising:
(a) means for receiving a work situation change event, and
(b) means for performing an adaptive response to said work situation change event,
thereby providing a solution to the Adaptive Focus GUI Problem, and
thereby enabling graphical user interfaces to adapt themselves to changes in user focus and work situations in a scalable way that was not previously available.

34. The computer readable memory of claim 33, wherein
(a) said means for receiving a work situation change event receives an event selected from the group consisting of initial invocation change events and full work situation change events and partial work situation change events and partial work situation context change events and partial work situation base directory change events and partial work situation collection change events and partial work situation role change events and partial work situation time change events and partial work situation focus variable change events and partial work situation focus variable group change events,
thereby helping to solve the Adaptive Focus GUI Problem, and
thereby helping to solve the Work Purpose Adaptation Problem, the Work Location Adaptation Problem, the Work Object Type Adaptation Problem, the Work Role Adaptation Problem, the Work Time Adaptation Problem, the Work Method Adaptation Problem, the Work Object Instance Adaptation Problem, and
thereby enabling graphical user interfaces to respond to events corresponding to work situation change concepts of why, where, what, who, when, and how.

35. The computer readable memory of claim 33, wherein
(a) said means for receiving a work situation change event receives a work situation change event from a source selected from the group consisting of human operators and external programs and a GUI program that is executing said means for receiving a work situation change event,
thereby helping to solve the Collection Adaptive Focus GUI Problem, and
thereby providing GUI interfaces with a practical means for responding to work situation change events that originate from both inside and outside the GUI program.

36. The computer readable memory of claim 33, wherein
(a) said means for performing an adaptive response obtains a work situation name from said work situation change event,
thereby helping to solve the Collection Adaptive Focus GUI Problem, and
thereby providing a practical means for clearly identifying a particular work situation to be installed as part of said adaptive response.

37. The computer readable memory of claim 33, wherein
(a) said means for performing an adaptive response uses a work situation name, and work situation data read from an adaptive data storage means, to perform a name matching operation to identify a work situation definition to be installed,
thereby helping to solve the Collection Adaptive Focus GUI Problem, and the Customized Adaptation Data Problem, and the Sharable Adaptation Data Problem, and the Scalable Adaptation Data Storage Problem,
and thereby providing a practical means for identifying a particular work situation definition to be installed as part of said adaptive response.

38. The computer readable memory of claim 33, wherein
(a) said means for performing an adaptive response uses a work situation name, and work situation data read from a context-sensitive adaptive data storage means, to perform a name matching operation to identify a work situation definition to be installed,
thereby helping to solve the Collection Adaptive Focus GUI Problem, and the Customized Adaptation Data Problem, and the Sharable Adaptation Data Problem, and the Scalable Adaptation Data Storage Problem,
and thereby providing a practical means for identifying in a context-sensitive way a particular work situation definition to be installed as part of said adaptive response.

39. The computer readable memory of claim 33, wherein
(a) said means for performing an adaptive response uses adaptive data read from an adaptive data storage means to perform said adaptive response,
thereby helping to solve the Collection Adaptive Focus GUI Problem, and the Customized Adaptation Data Problem, and the Sharable Adaptation Data Problem, and the Scalable Adaptation Data Storage Problem,
and thereby providing a practical means for obtaining adaptive data to be used in the performance of said adaptive response.

40. The computer readable memory of claim 33, wherein
(a) said means for performing an adaptive response uses adaptive data read from a context-sensitive adaptive data storage means to perform said adaptive response,
thereby helping to solve the Collection Adaptive Focus GUI Problem, and the Customized Adaptation Data Problem, and the Sharable Adaptation Data Problem, and the Scalable Adaptation Data Storage Problem,
and thereby providing a practical means for obtaining in a context-sensitive way adaptive data to be used in the performance of said adaptive response.

41. The computer readable memory of claim 33, wherein
(a) said means for performing an adaptive response performs one or more focus-gain or focus-loss actions,
thereby solving the Work Situation Focus Actions Problem, and
thereby providing a practical means for performing useful focus-gain and focus-loss actions as the GUI changes from an old work situation to said new work situation.

42. The computer readable memory of claim 33, wherein
(a) said means for performing an adaptive response uses information from definitions selected from the group consisting of context definitions and base directory definitions and collection type definitions and role definitions and timeset definitions and focus variable definitions and focus variable group definitions and GUI layout definitions and menu choice definitions,
thereby providing a practical means for using stored adaptation knowledge to help solve the Collection Adaptive Focus GUI Problem, and
thereby helping to solve the Work Purpose Adaptation Problem, the Work Location Adaptation Problem, the Work Object Type Adaptation Problem, the Work Role Adaptation Problem, the Work Time Adaptation Problem, the Work Method Adaptation Problem, the Work Object Instance Adaptation Problem, and
thereby providing a practical means for utilizing scalable, extensible, customized, and user-provided adaptation knowledge to adapt a graphical user interface to specific user-oriented work situations in ways that were not previously possible.

43. The computer readable memory of claim 33, wherein
(a) said means for performing an adaptive response expands a partial work situation change event into a full work situation,
thereby helping to solve the Adaptive Focus GUI problem, and
thereby providing users with a practical means for defining custom partial work situation expansion policies, and
thereby enabling users to focus on a new full work situation by providing only a partial work situation change event.

44. The computer readable memory of claim 33, wherein
(a) said means for performing an adaptive response expands a partial work situation change event into a full work situation using an expansion method selected from the group consisting of specific value expansion methods and normal value expansion methods and derived value expansion methods,
thereby helping to solve the Adaptive Focus GUI problem, and
thereby providing users with several practical methods for expanding partial situation change events into full situations in accordance with desired user policy preferences.

45. The computer readable memory of claim 33, wherein
(a) said means for performing an adaptive response overrides one or more full work situation values using work situation value specifiers contained within collection specifier instances,
thereby solving the Work Object Instance Adaptation Problem, and
thereby providing users with a practical means for associating particular work situation values with particular collection instances, and
thereby enabling users to conveniently override default work situation values that are defined by global site policies.

46. The computer readable memory of claim 33, wherein
(a) said means for performing an adaptive response modifies internal GUI data values selected from the group consisting of context values and base directory values and collection values and role values and timeset values and focus variable values and focus variable group values,
thereby helping to solve the Adaptive Focus GUI problem, and
thereby helping to solve the Work Purpose Adaptation Problem, the Work Location Adaptation Problem, the Work Object Type Adaptation Problem, the Work Role Adaptation Problem, the Work Time Adaptation Problem, the Work Method Adaptation Problem, the Work Object Instance Adaptation Problem, and
thereby providing a practical means for making work situation knowledge that is relevant to said new work situation available for use by internal GUI functions and external spawned command lines.

47. The computer readable memory of claim 33, wherein
(a) said means for performing an adaptive response modifies one or more GUI layout components selected from the group consisting of menu bars and menus and menu choices and toolbars and status bars and text labels and list boxes and radio buttons and drop down boxes and GUI layout components affected by focus variables and focus variable groups,
thereby helping to solve the Adaptive Focus GUI problem by updating visible GUI displays and controls in accordance with said new work situation, and
thereby helping to solve the Work Purpose Adaptation Problem, the Work Location Adaptation Problem, the Work Object Adaptation Problem, the Work Role Adaptation Problem, the Work Time Adaptation Problem, the Work Method Adaptation Problem, and
thereby providing users with one or more visual indications of the focus change from a previous work situation to a new work situation, and
thereby providing users with a new set of work operations that are relevant to said new work situation.

48. The computer readable memory of claim 33, wherein
(a) said means for performing an adaptive response communicates adaptation results to one or more destinations selected from the group consisting of computer memories and computer display screens and computer files and computer networks,
thereby helping to solve the Collection Adaptive Focus GUI Problem,
and thereby providing a practical means for displaying and storing adaptation results as part of said adaptive response.
